(19) United States
(12) Patent Application Publication
(10) Pub. No.: US 2026/0315955 A1
(43) Pub. Date: Oct. 15, 2026

(54) DESICCANT-BASED ATMOSPHERIC WATER GENERATOR POWERED BY VARIABLE PRESSURE

(71) Applicant: King Fahd University of Petroleum and Minerals, Dhahran (SA)

(72) Inventors: Mohamed Ali Mahmoud AHMED, Khobar (SA); Osman Kaleem SIDDIQUI, Dhahran (SA); Syed Mohammad Zubair ZUBAIR, Dhahran (SA)

(73) Assignee: King Fahd University of Petroleum and Minerals, Dhahran (SA)

(21) Appl. No.: 19/174,756

(22) Filed: Apr. 9, 2025

(51) Int. Cl. B01D 5/00; B01D 53/26

(52) U.S. Cl. CPC B01D 5/0087; B01D 5/009; B01D 53/263; B01D 2202/00; B01D 2221/16; B01D 2257/80

(57) ABSTRACT

A system for the production of water from air includes an air intake, a desiccant-based moisture extractor, a weak desiccant line, a weak desiccant cooling line, a dehumidifier, a strong desiccant line, a dry pressurized airline, a throttle valve, a humidifier, a compressor line, a compressor, and a freshwater storage tank. The dehumidifier includes a vessel, a water outlet, and a wet compressed air inlet. The humidifier includes a body, a strong desiccant outlet, and a wet air outlet. Further, the dehumidifier, the dry pressurized airline, the humidifier, and the compressor line form a closed gas loop. Furthermore, the weak desiccant line, the weak desiccant cooling line, the strong desiccant line, and the desiccant-based moisture extractor form a closed desiccant loop.

### STATEMENT REGARDING PRIOR DISCLOSURE BY THE INVENTORS

Aspects of the present disclosure are described in Ahmed, M. A. M.; Siddiqui, O. K.; Zubair, S. M., “Eco-friendly atmospheric water generation: A novel desiccant-based variable pressure humidification-dehumidification system” published in Volume 314, Energy Conversion and Management on Jun. 27, 2024, which is incorporated herein by reference in its entirety.

### BACKGROUND

### Technical Field

The present disclosure relates generally to water generation systems and methods and, more particularly, to atmospheric water generation utilizing desiccant-based moisture extraction integrated with variable pressure humidification-dehumidification processes for improved performance in freshwater production.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Influenced by dynamics like rising populations, economic growth, and evolving consumption patterns, there has been an estimated annual increment of approximately 1% in water consumption. Predictions, as outlined in references [See: Tlili I, Alkanhal T A, Othman M, Dara R N, Shafee A (2020) Water management and desalination in KSA view 2030: Case study of solar humidification and dehumidification system. J Therm Anal calorim, 139:3745-56], anticipate a 30% increase in the requirement for freshwater by the end of this decade. Research [See: Zhang Y, Palomba V, Frazzica A (2022) Understanding the effect of materials, design criteria and operational parameters on the adsorption desalination performance—A review. Energy Convers Manag, 269:116072; Liang Y, Xu J, Luo X, Chen J, Yang Z, Chen Y (2022) Cradle-to-grave life cycle assessment of membrane distillation systems for sustainable seawater desalination. Energy Convers Manag 266:115740] reveals that roughly 40% of the world's population is currently experiencing a shortage of freshwater. Contrasting reports, as detailed in [See: Liu T K, Ye J-A, Sheu H-Y (2022) Exploring the social acceptability for the desalination plant project: Perceptions from the stakeholders. Desalination, 532:115757], projects that this figure might rise to 60%. To combat water scarcity, strategies like water conservation, recycling, desalination, efficient usage, and storage are employed.

In scenarios where alternative methods are inadequate, seawater desalination becomes required, as noted in [See: Pistocchi A, Bleninger T, Breyer C, Caldera U, Dorati C, Ganora D, et al. (2020) Can seawater desalination be a win-win fix to our water cycle? Water Res, 182:115906]. Many countries, including those in the Middle East and North Africa (MENA) region, have established desalination plants to meet the increasing freshwater needs, as described in [See: Wang W, Shi Y, Zhang C, Hong S, Shi L, Chang J, et al. (2019) Simultaneous production of fresh water and electricity via multistage solar photovoltaic membrane distillation. Nat Commun, 10.3012]. Despite their effectiveness in generating drinkable water, the construction of these desalination plants is hindered by operational and capital expenses, as elaborated in [See: Elhashimi M A, Gee M, Abbasi B (2022) Unconventional desalination: The use of cyclone separators in HDH desalination to achieve zero liquid discharge. Desalination, 539:115932].

Desalination processes are categorized based on their operational mechanisms, which can be thermodynamic, mechanical, or electrical, as illustrated in [See: Shalaby S M, Sharshir S W, Kabeel A E, Kandeal A W, Abosheiasha H F, Abdelgaied M, et al (2022) Reverse osmosis desalination systems powered by solar energy: Preheating techniques and brine disposal challenges—A detailed review. Energy Convers Manag, 251:114971]. A notable example of a thermodynamically driven approach is the Multiple Effect Distillation (MED), detailed in [See: Mohammed R H, Ibrahim M M, Abu-Heiba A (2021) Exergoeconomic and multi-objective optimization analyses of an organic Rankine cycle integrated with multi-effect desalination for electricity, cooling, heating power, and freshwater production. Energy Convers Manag, 231:113826]. MED excels in seawater desalination, but its extensive maintenance and high initial costs limit its applicability in smaller settings.

In scenarios with limited financial and technical resources, exploring alternative methods for seawater desalination becomes relevant. Humidification Dehumidification (HDH) systems, noted for their eco-friendly attributes, are particularly well-suited for small-scale and isolated settings, as outlined in [See: Elbassoussi M H, Mohammed R H, Zubair S M (2020) Thermoeconomic assessment of an adsorption cooling/desalination cycle coupled with a water-heated humidification-dehumidification desalination unit. Energy Convers Manag, 223:113270]. The construction and maintenance of HDH systems are relatively straightforward, rendering them an effective solution in areas with scarce technical support infrastructure. HDH cycles can be grouped by the characteristics of the water or air loop, specifically whether they operate in a closed or open circuit, as mentioned in [See: Lienhard J, Antar M A, Bilton A, Blanco J, Zaragoza G (2012) SOLAR DESALINATION. Annu Rev Heat Transf, 15:277-347].

The Humidification Dehumidification (HDH) desalination system, a prominent technology in the field of desalination, combines a low-temperature humidifier, operating lower than the boiling point, with a condenser using air as the transfer medium. This setup echoes the functionality of an advanced, solar-driven distillation unit tailored for smaller desalination initiatives. Historically, the capital requirements for such HDH technologies have been substantial, with cost assessments averaging approximately $30 per cubic meter, as outlined in [See: Narayan G P, Lienhard J H (2012) Thermal Design of Humidification-Dehumidification Systems for Affordable Small-Scale Desalination. IDA J Desalin Water Reuse, 4:24-34]. However, the economic feasibility benchmark in this sector is generally under $5 per cubic meter. Efforts to decrease expenses have included the introduction of innovations such as bubble column dehumidifiers, enhancements in system thermodynamics, and the integration of solar hybrids. Recent advancements have resulted in solar air-heated HDH systems being priced at about $9.74 m⁻³, underscoring the impact of continuous research on making the technology more cost-effective, as indicated in [See: Kabeel A E, Elmaaty T A, El-Said E M S (2013) Economic analysis of a small-scale hybrid air HDH-SSF (humidification and dehumidification-water flashing evaporation) desalination plant. Energy, 53:306-11].

Muller-Holst [See: Müller-Holst H (2007) Solar thermal desalination using the multiple effect humidification (MEH)-method. NATO Secur through Sci Ser C Environ Secur] introduced the multi-effect humidification method for freshwater production, utilizing solar energy and reducing energy needs to 120 kWh m⁻³. This method became commercially viable, marking a milestone in HDH system development. Al-Hallaj et al. [See: Al-Hallaj S, Farid M M, Tamimi A R (1998) Solar desalination with a humidification-dehumidification cycle: Performance of the unit. Desalination, 120:273-80] discussed a setup characterized by a sealed atmospheric loop that harnesses solar power for its operation. This system uniquely employs the feed water in dual roles, both for the process of condensation and for initial thermal elevation, noting that lower temperatures enhance system performance.

Nawayseh et al. [See: Nawayseh N K, Farid M M, Omar A A, Sabirin A (1999) Solar desalination based on humidification process—II. Computer simulation. Energy Convers Manag, 40:1441-61] examined a low-temperature forced convection HDH system, revealing minimal performance gains from varying air flow rates under different heating sources. In the study conducted by Chafik [See: Chafik E (2003) A new type of seawater desalination plants using solar energy. Desalination, 156:333-48], a solar-powered water desalination system capable of generating ten cubic meters of drinkable water was developed. This system utilized solar energy for both the humidification process and air temperature regulation.

The research conducted by Houcine et al. [See: Houcine I, BenAmara M, Guizani A, Maâlej M (2006) Pilot plant testing of a new solar desalination process by a multiple-effect-humidification technique. Desalination, 196:105-24] focused on a pilot-scale implementation of a multi-effect humidification technique. This pilot plant achieved a consistent daily yield of 355 kilograms of water over six months. In their empirical study, Ben Amara et al. [See: Ben Amara M, Houcine I, Guizani A, Măalej M (2004) Experimental study of a multiple-effect humidification solar desalination technique. Desalination, 170:209-21] investigated a solar-powered multi-effect humidification process, pinpointing an optimal water-to-dry air mass flow ratio at 45%. Further scrutiny into diverse HDH desalination cycles was undertaken by Narayan et al. [See: Narayan G P, Sharqawy M H, Lienhard V J H, Zubair S M (2010) Thermodynamic analysis of humidification dehumidification desalination cycles. Desalin Water Treat, 16:339-53]. This research introduced several advancements, such as multi-extraction and modifiable pressure cycles, aimed at boosting the Gain Output Ratio (GOR) in these systems.

In the rapidly advancing field of solar-powered water desalination technologies, enhancements in system efficiency and economic viability have been observed. Alrbai et al. [See: Alrbai M, Hayajneh H S, Omar A, Alkader M A, Al-Riaty H (2021) Experimental investigation of lab-scale solar powered Electrodialysis system with corrugated membrane configuration. Sol Energy, 224:390-400] detailed an innovative electrodialysis system employing corrugated membranes, which improved ion transfer rates, yielding higher salt removal efficiencies and operational effectiveness in solar-powered setups. Concurrently, Alrbai et al. [See: Alrbai M, Hayajneh H, Arakza F, Enizat J, Al-Dahidi S, Al-Ghussain L, et al. (2022) Techno-economic analysis of a solar-powered humidification-dehumidification desalination system under fogging effect. Sustain Energy Technol Assessments, 53] explored a solar-powered humidification-dehumidification system, emphasizing the integration of fogging nozzles to reduce energy consumption while increasing freshwater production, demonstrating a gained output ratio improvement by 23.68% over traditional nozzle configurations.

Additionally, Alrbai et al. [See: Alrbai M, Enizat J, Hayajneh H, Qawasmeh B, Al-Dahidi S (2022) Energy and exergy analysis of a novel humidification-dehumidification desalination system with fogging technique. Desalination, 522] conducted energy and exergy analysis on a similar system, further highlighting the benefits of fogging nozzles in enhancing system productivity and reducing entropy generation. Alrbai et al. [See: Alrbai M, Hayajneh H S, Al-Dahidi S, Alahmer A (2022) Thermodynamics analysis of a lab-scale humidification-dehumidification desalination system employing solar energy and fogging approach. Sol Energy, 247:397-407] also analyzed a lab-scale humidification-dehumidification system, demonstrating how optimal configurations of solar energy inputs can boost system performance and exergy efficiency.

In research pertaining to variable pressure HDH systems, Narayan et al. [See: Narayan G P, McGovern R K, Lienhard V J H, Zubair S M (2011) Variable pressure humidification dehumidification desalination system. ASME/JSME 2011 8th Therm. Eng. Jt. Conf. AJTEC, 2011] observed enhanced performance over conventional HDH systems yet noted that these systems still fell short of other methodologies like reverse osmosis (RO) in certain respects. Substantial research efforts have focused on refining HDH system design to increase freshwater output and minimize energy expenditure. Sharqawy et al. [See: Sharqawy M H, Antar M A, Zubair S M, Elbashir A M (2014) Optimum thermal design of humidification dehumidification desalination systems. Desalination, 349:10-21] examined two HDH cycle designs using a mathematical model, while Saeed et al. [See: Saeed A, Antar M A, Sharqawy M H, Badr H M (2016) CFD modeling of humidification dehumidification distillation process. Desalination, 395:46-56] explored the HDH cycle in a rectangular cavity, identifying a mass transfer ratio of 1.5 as optimal. Zubair et al. [See: Zubair M I, Al-Sulaiman F A, Antar M A, Al-Dini S A, Ibrahim N I (2017) Performance and cost assessment of solar driven humidification dehumidification desalination system. Energy Convers Manag, 132:28-39] optimized an HDH cycle with solar-evacuated tube collectors, finding geographical variations in freshwater production.

Research has focused on reducing entropy generation in the heat and mass exchange process to address the suboptimal performance of the HDH. Strategies like thermodynamic balancing [See: Narayan G P, Chehayeb K M, McGovern R K, Thiel G P, Zubair S M, Lienhard V JH (2013) Thermodynamic balancing of the humidification dehumidification desalination system by mass extraction and injection. Int J Heat Mass Transf, 57:756-70] and reducing enthalpy disparity between streams [See: Xu H, Jiang S, Xie M X, Jia T, Dai Y J (2022) Technical improvements and perspectives on humidification-dehumidification desalination-A review. Desalination, 541:116029] have improved cycle efficiency, particularly with additional air mass extractions [See: Ahmed M A, Qasem N A A, Zubair S M, Gandhidasan P, Bahaidarah H M (2018) Thermodynamic balancing of the regeneration process in a novel liquid desiccant cooling/desalination system. Energy Convers Manag, 176:86-98].

Hybridization strategies and alternative energy integration approaches have been extensively investigated to enhance HDH system performance. These include the integration of adsorption desalination systems [See: Qasem N A A, Zubair S M (2019) Performance evaluation of a novel hybrid humidification-dehumidification (air-heated) system with an adsorption desalination system. Desalination, 461:37-54] and heat pump applications [See: Lawal D, Antar M, Khalifa A, Zubair S, Al-Sulaiman F (2018) Humidification-dehumidification desalination system operated by a heat pump. Energy Convers Manag, 161:128-40]. Systems utilizing low-grade waste heat [See: Santosh R, Yoo C H, Kim Y-D (2022) Performance evaluation and optimization of humidification-dehumidification desalination system for low-grade waste heat energy applications. Desalination, 526:115516] and solar energy integration [See: Negharchi S M, Najafi A, Nejad A A, Ghadimi N (2021) Determination of the optimal model for solar humidification dehumidification desalination cycle with extraction and injection. Desalination, 506:114984] have also demonstrated potential.

Performance optimization through heat recovery mechanisms has been extensively studied by Zubair et al. [See: Zubair S M, Antar M A, Elmutasim S M, Lawal D U (2018) Performance evaluation of humidification-dehumidification (HDH) desalination systems with and without heat recovery options: An experimental and theoretical investigation. Desalination, 436:161-75] and Ghalavand et al. [See: Ghalavand A, Hatamipour M S, Ghalavand Y (2021) Performance evaluation of a multi-stage humidification compression with heat recovery based on mathematical modeling. Desalination, 515:115189]. Narayan et al. [See: Narayan G P, John M G, Zubair S M, V JHL (2013) Thermal design of the humidification dehumidification desalination system: An experimental investigation. Int J Heat Mass Transf, 58:740-8] empirically demonstrated a 45% improvement in HDH performance with thermodynamic equalization. Sharqawy et al. [See: Sharqawy M H, Al-Shalawi I, Antar M A, Zubair S M (2017) Experimental investigation of packed-bed cross-flow humidifier. Appl Therm Eng, 117:584-90] evaluated the efficiency of a cross-flow packed-bed humidifier, finding a model agreement within a 6% variance at high capacity ratios.

The abundant presence of water vapor in the atmosphere presents a considerable opportunity for freshwater extraction, including in coastal regions where atmospheric water generators are emerging as promising technologies, as evidenced by Ahmed et al. [See: Ahmed M A, Zubair S M, Abido M A, Bahaidarah H M (2018) An innovative closed-air closed-desiccant HDH system to extract water from the air: A case for zero-brine discharge system. Desalination, 445:236-48]. These systems typically function by cooling humid air until its moisture content condenses, although this process can increase energy consumption due to the intensive cooling required.

Comprehensive research on various compressor and expander configurations has yielded insights into system optimization. Iglesias and Favrat [See: Iglesias A, Favrat D (2014) Innovative isothermal oil-free co-rotating scroll compressor-expander for energy storage with first expander tests. Energy Convers Manag, 85:565-72] conducted investigations on an isothermal scroll compressor-expander, achieving operational pressure of 4.5 bar at rotational speeds of 8,000-10,000 RPM, with efficiency metrics ranging between 70-75%. Ko et al. [See: Ko Y, Park S, Jin S, Kim B, Jeong J H (2013) The selection of volume ratio of two-stage rotary compressor and its effects on air-to-water heat pump with flash tank cycle. Appl Energy, 104:187-96] performed a comparative analysis between twin rotary and two-stage rotary systems, demonstrating enhanced efficiency characteristics of the twin rotary configuration at lower frequencies and enhanced adaptability for low-temperature operations. In related research, Hou and Zhang [See: Hou S, Zhang H (2009) An open reversed Brayton cycle with regeneration using moist air for deep freeze cooled by circulating water. Int J Therm Sci, 48:218-23] investigated axial compressor implementation within the Brayton cycle, achieving pressure ratios between 2 and 3.5, while demonstrating capability for mass flow rate, pressure ratio, and refrigerant capacity regulation through rotational speed adjustment.

Atmospheric water harvesting has emerged as a viable solution to global water scarcity through methods including fog collection, dew harvesting, and air-to-water systems. Modi and Shukla [See: Modi K V., Shukla D L (2018) Regeneration of liquid desiccant for solar air-conditioning and desalination using hybrid solar still. Energy Convers Manag, 171:1598-1616] explored desiccant regeneration processes within solar-powered hybrid systems combining air conditioning with desalination capabilities. The integration of desiccant dehumidification with absorption cooling has been investigated to achieve simultaneous water production and cooling effects [See: Su B, Han W, Jin H (2017) An innovative solar-powered absorption refrigeration system combined with liquid desiccant dehumidification for cooling and water. Energy Convers Manag, 153:515-25].

Kabeel et al. [See: Kabeel A E, Abdelgaied M, Zakaria Y (2017) Performance evaluation of a solar energy assisted hybrid desiccant air conditioner integrated with HDH desalination system. Energy Convers Manag, 150:382-91] evaluated a hybrid desiccant air conditioner integrated with an HDH desalination system, demonstrating the viability of simultaneous cooling and water production. Ahmed et al. [See: Ahmed M A M, Shamet O, Lawal D U, Antar M A, Zubair S M (2024) Proof of Concept of the Regeneration Part in a Novel Desiccant-Based Atmospheric Water Generator. Arab J Sci Eng, 49:2813-29] conducted experimental investigations into the properties of freshwater generated by a desiccant-based atmospheric water generator, focusing on water quality parameters, including salinity, electrical conductivity, and resistivity. Their findings demonstrated salinity levels of approximately 23 ppm, a level that is both acceptable and safe for human consumption, underscoring the efficacy of this method in providing potable water quality.

US20210254844A1 describes an atmospheric water generator having separate air dryer and humidifier-dehumidifier subsystems connected through desiccant lines. The system employs multiple air dryers in series to process ambient air and transfer moisture to a desiccant medium, which then undergoes regeneration in a separate loop. The system operates at atmospheric pressure throughout the cycle.

US20240271396A1 describes a reactor-based system where hot dry air flows through a water-saturated desiccant to desorb water, followed by heat exchange and condensation steps. While the system implements a closed-loop pathway for the air circuit, it relies primarily on temperature differential rather than pressure variation for water extraction.

US20180126325A1 describes a liquid desiccant system with vertically separated chambers, where hydrated desiccant is pumped upward for regeneration and returns via gravity-assisted flow. The system focuses on passive flow control through capillary action but maintains consistent pressure conditions during operation.

US20220195706A1 describes an atmospheric water generation system utilizing fluid-desiccant flow with temperature control to encourage water vapor absorption and subsequent release. The system implements compressors for air pre-conditioning but does not integrate this with desiccant regeneration in a unified cycle.

Each of the aforementioned references suffers from one or more drawbacks hindering their adoption, such as limited water production efficiency, high energy consumption, complex maintenance requirements, and reduced performance in varying atmospheric conditions. These systems, while demonstrating various approaches to atmospheric water generation, operate with either constant pressure conditions or limited pressure variation, and do not fully leverage the relationship between pressure differential and mass transfer efficiency in both the moisture extraction and desiccant regeneration processes of a unified system. Traditional atmospheric water generation systems often struggle with thermal losses, entropy generation, and mass transfer inefficiencies that impact their economic viability. Additionally, existing systems frequently require substantial infrastructure support and fail to maintain consistent performance across diverse operating environments. Accordingly, it is one object of the present disclosure to provide an integrated system that addresses these limitations while improving overall system efficiency and operational flexibility.

### SUMMARY

In an exemplary embodiment, a system for production of water from air is described, comprising: an air intake, which conveys humid air from the environment to a desiccant-based moisture extractor; the desiccant-based moisture extractor, wherein the humid air is dried with a desiccant to produce a weak desiccant and a dry air, wherein the weak desiccant is conveyed to a dehumidifier through a weak desiccant line and the dry air is directed away from the air intake; the dehumidifier comprising a vessel, a water outlet, and a wet compressed air inlet, wherein a weak desiccant cooling line passes through the vessel of the dehumidifier and conveys the weak desiccant to a humidifier, wherein the wet compressed air inlet allows for a wet compressed air to pass over the weak desiccant cooling line, wherein the wet compressed air is cooled by exposure to the weak desiccant cooling line, producing a dry pressurized air and condensed water, wherein the water outlet conveys the condensed water to a freshwater storage tank; a dry pressurized air line, connecting the vessel of the dehumidifier to a body of the humidifier, wherein a throttle valve is disposed in line with the dry pressurized air line downstream from the dehumidifier and upstream from the humidifier; the throttle valve, wherein the throttle valve is configured to allow the dry pressurized air from the dehumidifier to flow into the humidifier, thereby introducing a dry air into the humidifier; the humidifier comprising the body, a strong desiccant outlet, and a wet air outlet, wherein the dry air is exposed to weak desiccant to produce a wet air and strong desiccant, wherein the wet air is fed through the wet air outlet to a compressor line, and the strong desiccant is conveyed to the desiccant-based moisture extractor through a strong desiccant line; the compressor line, which connects the wet air outlet to the wet compressed air inlet; and the compressor, wherein the compressor sits in line with the compressor line and compresses the wet air to form the wet compressed air, wherein the wet compressed air is fed to the wet compressed air inlet, wherein the dehumidifier, the dry pressurized air line, the humidifier, and the compressor line form a closed gas loop, and wherein the weak desiccant line, the weak desiccant cooling line, the strong desiccant line, and the desiccant-based moisture extractor form a closed desiccant loop.

In some embodiments, the Gain Output Ratio is greater than or equal to 2.00.

In some embodiments, the Gain Output Ratio is greater than or equal to 2.20.

In some embodiments, the recovery ratio is greater than or equal to 2.00.

In some embodiments, the recovery ratio is greater than or equal to 2.40.

In some embodiments, the Gain Output Ratio is greater than or equal to 1.20 when operated at a pressure ratio of 1.4, assuming an effectiveness parameter of 0.7, and wherein a pressure of the humidifier is 80 kPa.

In some embodiments, the Gain Output Ratio is greater than or equal to 1.30 when operated at a pressure ratio of 1.4, assuming an effectiveness parameter of 0.7, and wherein a pressure of the humidifier is 70 kPa.

In some embodiments, the Gain Output Ratio is greater than or equal to 1.37 when operated at a pressure ratio of 1.4, assuming an effectiveness parameter of 0.7, and wherein a pressure of the humidifier is 60 kPa.

In some embodiments, the Gain Output Ratio is greater than or equal to 1.47 when operated at a pressure ratio of 1.4, assuming an effectiveness parameter of 0.7, and wherein a pressure of the humidifier is 50 kPa.

In some embodiments, the Gain Output Ratio is greater than or equal to 1.60 when operated at a pressure ratio of 1.4, assuming an effectiveness parameter of 0.7, and wherein a pressure of the humidifier is 40 kPa.

In some embodiments, the recovery ratio is greater than or equal to 2.00 when operated at a pressure ratio of 1.4, assuming an effectiveness parameter of 0.7, and wherein a pressure of the humidifier is 80 kPa.

In some embodiments, the recovery ratio is greater than or equal to 2.075 when operated at a pressure ratio of 1.4, assuming an effectiveness parameter of 0.7, and wherein a pressure of the humidifier is 70 kPa.

In some embodiments, the recovery ratio is greater than or equal to 2.15 when operated at a pressure ratio of 1.4, assuming an effectiveness parameter of 0.7, and wherein a pressure of the humidifier is 60 kPa.

In some embodiments, the recovery ratio is greater than or equal to 2.20 when operated at a pressure ratio of 1.4, assuming an effectiveness parameter of 0.7, and wherein a pressure of the humidifier is 50 kPa.

In some embodiments, the recovery ratio is greater than or equal to 2.30 when operated at a pressure ratio of 1.4, assuming an effectiveness parameter of 0.7, and wherein a pressure of the humidifier is 40 kPa.

In some embodiments, the total freshwater production is greater than or equal to a water mass flow rate of 20×10⁻³ kg·s⁻¹ when operated at a pressure ratio of 1.4, assuming an effectiveness parameter of 0.7, and wherein a pressure of the humidifier is 80 kPa.

In some embodiments, the total freshwater production is greater than or equal to a water mass flow rate of 20.8×10⁻³ kg·s⁻¹ when operated at a pressure ratio of 1.4, assuming an effectiveness parameter of 0.7, and wherein a pressure of the humidifier is 70 kPa.

In some embodiments, the total freshwater production is greater than or equal to a water mass flow rate of 21.5×10⁻³ kg·s⁻¹ when operated at a pressure ratio of 1.4, assuming an effectiveness parameter of 0.7, and wherein a pressure of the humidifier is 60 kPa.

In some embodiments, the total freshwater production is greater than or equal to a water mass flow rate of 22.0×10⁻³ kg·s⁻¹ when operated at a pressure ratio of 1.4, assuming an effectiveness parameter of 0.7, and wherein a pressure of the humidifier is 50 kPa.

In some embodiments, the total freshwater production is greater than or equal to a water mass flow rate of 23.0×10⁻³ kg·s⁻¹ when operated at a pressure ratio of 1.4, assuming an effectiveness parameter of 0.7, and wherein a pressure of the humidifier is 40 kPa.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings.

FIG. 1 is a schematic diagram of a system for production of water from air, depicting integration of variable pressure humidification-dehumidification components with desiccant-based moisture extraction, according to certain embodiments.

FIG. 2 is an exemplary chart of primary desalination and/or water filtration processes implemented in the art for reference.

FIG. 3A is an exemplary graph depicting correlation between predicted and experimental air temperature values at the moisture extractor outlet, according to certain embodiments.

FIG. 3B is an exemplary graph depicting correlation between predicted and experimental humidity ratio values at the moisture extractor outlet, according to certain embodiments.

FIG. 3C is an exemplary graph depicting correlation between predicted and experimental desiccant temperature values at the moisture extractor outlet, according to certain embodiments.

FIG. 3D is an exemplary graph depicting correlation between predicted and experimental desiccant concentration values at the moisture extractor outlet, according to certain embodiments.

FIG. 4A is an exemplary graph depicting Gain Output Ratio validation data for the humidification-dehumidification system at effectiveness parameter of 0.8, according to certain embodiments.

FIG. 4B is an exemplary graph depicting Mass Ratio validation data for the humidification-dehumidification system at effectiveness parameter of 0.8, according to certain embodiments.

FIG. 4C is an exemplary graph depicting Recovery Ratio validation data for the humidification-dehumidification system at effectiveness parameter of 0.8, according to certain embodiments.

FIG. 5A is an exemplary graph depicting Gain Output Ratio variation with pressure ratio at effectiveness parameter of 0.7, according to certain embodiments.

FIG. 5B is an exemplary graph depicting Mass Flow Ratio variation with pressure ratio at effectiveness parameter of 0.7, according to certain embodiments.

FIG. 5C is an exemplary graph depicting Recovery Ratio variation with pressure ratio at effectiveness parameter of 0.7, according to certain embodiments.

FIG. 6A is an exemplary graph depicting Gain Output Ratio variation with pressure ratio at effectiveness parameter of 0.8, according to certain embodiments.

FIG. 6B is an exemplary graph depicting Mass Flow Ratio variation with pressure ratio at effectiveness parameter of 0.8, according to certain embodiments.

FIG. 6C is an exemplary graph depicting Recovery Ratio variation with pressure ratio at effectiveness parameter of 0.8, according to certain embodiments.

FIG. 7A is an exemplary graph depicting effectiveness variations in the humidifier for both desiccant and air sides across pressure ratios, according to certain embodiments.

FIG. 7B is an exemplary graph depicting effectiveness variations in the dehumidifier across pressure ratios, according to certain embodiments.

FIG. 8A is an exemplary graph depicting compressor power requirements versus pressure ratio at effectiveness parameter of 0.7, according to certain embodiments.

FIG. 8B is an exemplary graph depicting compressor power requirements versus pressure ratio at effectiveness parameter of 0.8, according to certain embodiments.

FIG. 9A is an exemplary graph depicting freshwater production from the throttle valve versus pressure ratio at effectiveness parameter of 0.7, according to certain embodiments.

FIG. 9B is an exemplary graph depicting freshwater production from the dehumidifier versus pressure ratio at effectiveness parameter of 0.7, according to certain embodiments.

FIG. 9C is an exemplary graph depicting total system freshwater production versus pressure ratio at effectiveness parameter of 0.7, according to certain embodiments.

FIG. 10A is an exemplary graph depicting throttle valve freshwater production versus pressure ratio at effectiveness parameter of 0.8, according to certain embodiments.

FIG. 10B is an exemplary graph depicting dehumidifier freshwater production versus pressure ratio at effectiveness parameter of 0.8, according to certain embodiments.

FIG. 10C is an exemplary graph depicting total system freshwater production versus pressure ratio at effectiveness parameter of 0.8, according to certain embodiments.

FIG. 11A is an exemplary graph depicting Gain Output Ratio variation with maximum desiccant temperature at effectiveness parameter of 0.7, according to certain embodiments.

FIG. 11B is an exemplary graph depicting mass ratio variation with maximum desiccant temperature at effectiveness parameter of 0.7, according to certain embodiments.

FIG. 11C is an exemplary graph depicting recovery ratio variation with maximum desiccant temperature at effectiveness parameter of 0.7, according to certain embodiments.

FIG. 12A is an exemplary graph depicting Gain Output Ratio variation with maximum desiccant temperature at effectiveness parameter of 0.8, according to certain embodiments.

FIG. 12B is an exemplary graph depicting mass ratio variation with maximum desiccant temperature at effectiveness parameter of 0.8, according to certain embodiments.

FIG. 12C is an exemplary graph depicting recovery ratio variation with maximum desiccant temperature at effectiveness parameter of 0.8, according to certain embodiments.

FIG. 13A is an exemplary graph depicting Gain Output Ratio variation with minimum desiccant temperature at effectiveness parameter of 0.7, according to certain embodiments.

FIG. 13B is an exemplary graph depicting mass ratio variation with minimum desiccant temperature at effectiveness parameter of 0.7, according to certain embodiments.

FIG. 13C is an exemplary graph depicting recovery ratio variation with minimum desiccant temperature at effectiveness parameter of 0.7, according to certain embodiments.

FIG. 14A is an exemplary graph depicting Gain Output Ratio variation with minimum desiccant temperature at effectiveness parameter of 0.7, according to certain embodiments.

FIG. 14B is an exemplary graph depicting mass ratio variation with minimum desiccant temperature at effectiveness parameter of 0.7, according to certain embodiments.

FIG. 14C is an exemplary graph depicting recovery ratio variation with minimum desiccant temperature at effectiveness parameter of 0.7, according to certain embodiments.

FIG. 15A is an exemplary graph depicting the variation in the gain output ratio with the top air temperature at 80% relative humidity, according to certain embodiments.

FIG. 15B is an exemplary graph depicting Gain Output Ratio variation with top air temperature at 90% relative humidity, according to certain embodiments.

FIG. 15C is an exemplary graph depicting Gain Output Ratio variation with top air temperature at 100% relative humidity, according to certain embodiments.

FIG. 16A is an exemplary graph depicting the effect of desiccant temperature and concentration on the Gain Output Ratio, according to certain embodiments.

FIG. 16B is an exemplary graph depicting system productivity variation with desiccant temperature and concentration, according to certain embodiments.

FIG. 17A is an exemplary graph depicting the relationship between humidifier packing material volume and Gain Output Ratio across different top temperatures, according to certain embodiments.

FIG. 17B is an exemplary graph depicting the effects of dehumidifier surface area on system performance, according to certain embodiments.

FIG. 18 is an illustration of a non-limiting example of details of computing hardware used in the computing system, according to certain embodiments.

FIG. 19 is an exemplary schematic diagram of a data processing system used within the computing system, according to certain embodiments.

FIG. 20 is an exemplary schematic diagram of a processor used with the computing system, according to certain embodiments.

FIG. 21 is an illustration of a non-limiting example of distributed components that may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system for production of water from air that integrates desiccant-based moisture extraction with variable pressure operation to enhance mass transfer efficiency and thermal performance. The present system provides water extraction capabilities without requiring seawater input or brine disposal. The system implements a closed-loop architecture that maximizes resource utilization while minimizing energy consumption through strategic pressure and temperature management. In particular, the present system incorporates a desiccant-based moisture extractor integrated with a humidification-dehumidification (HDH) apparatus operating under variable pressure conditions. The system includes a closed gas loop and a closed desiccant loop configured for continuous operation. The closed desiccant loop maintains desiccant circulation between the desiccant-based moisture extractor and a dehumidifier-humidifier assembly. The desiccant-based moisture extractor functions to extract moisture from environmental air using strong desiccant, producing weak desiccant that flows to the dehumidifier-humidifier assembly. The dehumidifier-humidifier assembly processes the weak desiccant to generate freshwater output while regenerating strong desiccant for return to the desiccant-based moisture extractor. The system of the present disclosure can be operated continuously to extract water from environmental air while maintaining closed-loop desiccant circulation, enabling sustained freshwater production without external water input requirements, making it suitable for implementation in coastal and inland locations where atmospheric humidity is available for extraction.

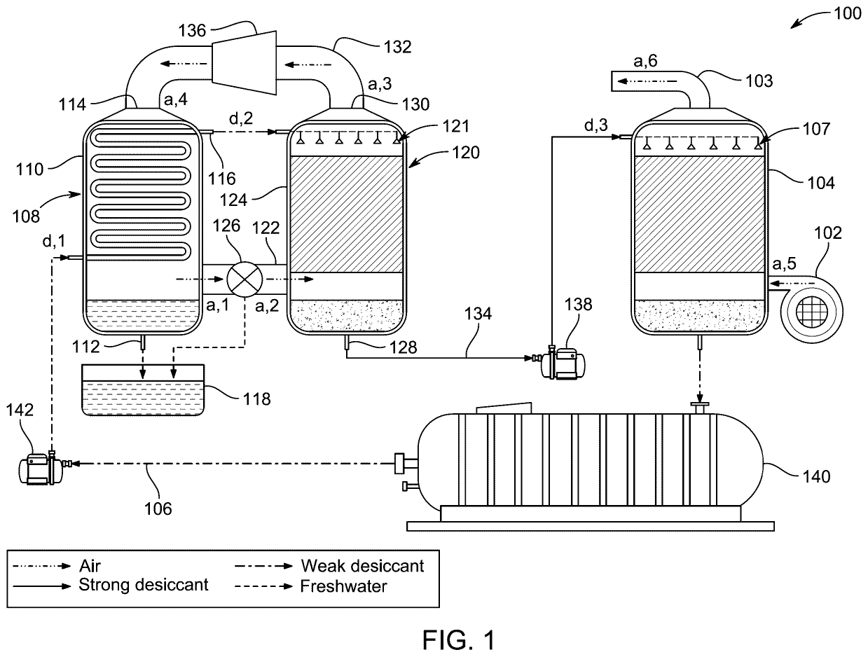

FIG. 1 illustrates an exemplary schematic diagram of a system (as represented by reference numeral 100) for production of water from air, as per embodiments of the present disclosure. The system 100 represents a solution for atmospheric water generation that combines multiple technological innovations in a unified design. In particular, the system 100 of the present disclosure integrates desiccant-based moisture extraction with variable pressure humidification-dehumidification processes to achieve enhanced water production efficiency. The system 100 comprises two primary subsystems: a desiccant-based moisture extractor and a variable pressure HDH unit, operating in a coordinated manner to extract water from atmospheric air while minimizing energy consumption.

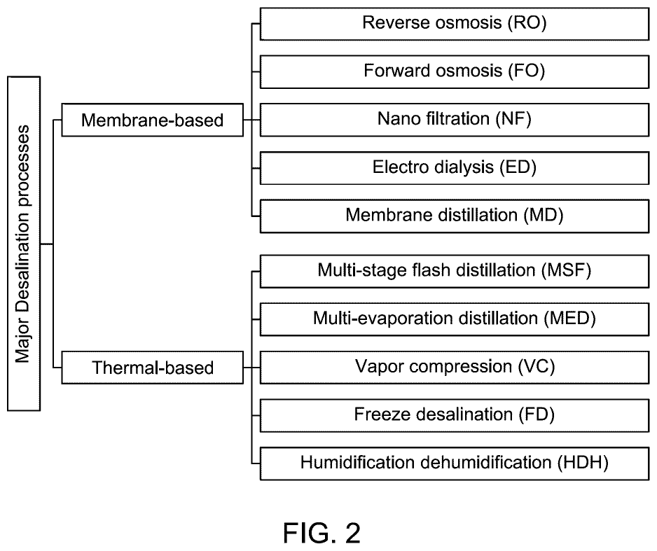

For reference, FIG. 2 presents a hierarchical classification of major desalination processes, categorizing them into two primary branches: membrane-based processes and thermal-based processes. The membrane-based processes encompass multiple technologies, including Reverse Osmosis (RO), Forward Osmosis (FO), Nano Filtration (NF), Electro dialysis (ED), and Membrane Distillation (MD). These membrane-based systems utilize selective barrier materials to achieve separation of water molecules from dissolved solids through various driving forces including pressure differentials, electrical potential, and concentration gradients. The thermal-based branch of desalination processes also encompass multiple technologies including Multi-Stage Flash Distillation (MSF), Multi-Evaporation Distillation (MED), Vapor Compression (VC), Freeze Desalination (FD), and Humidification Dehumidification (HDH). These thermal processes operate through phase change mechanisms, utilizing heat energy to separate water from dissolved solids through processes such as evaporation, condensation, freezing, or combined humidification-dehumidification cycles. The present disclosure focuses on advancing HDH technology through integration with desiccant-based atmospheric water generation, addressing limitations in conventional thermal desalination approaches while achieving enhanced performance metrics as depicted in the system 100 of FIG. 1.

As illustrated in FIG. 1, the system 100 includes an air intake 102, which conveys humid air from the environment to a desiccant-based moisture extractor 104. The desiccant-based moisture extractor 104 utilizes a desiccant material configured to dry the humid air. In the desiccant-based moisture extractor 104, the humid air is dried with the desiccant to produce a weak desiccant and a dry air. Specifically, within the desiccant-based moisture extractor 104, the humid air contacts a concentrated desiccant solution, typically comprising lithium chloride (LiCl), resulting in moisture transfer from the air to the desiccant. This process produces two output streams: a dried air stream that is directed away from the desiccant-based moisture extractor 104 via the dry air exhaust 103, and a diluted (weak) desiccant solution that requires regeneration.

The weak desiccant is conveyed to a dehumidifier 108 through a weak desiccant line 106 and the dry air is directed away from the dry air exhaust 103. As shown, the weak desiccant flows through the weak desiccant line 106 to the dehumidifier 108, while the dry air output is directed away from the air intake 102 through a designated flow path to prevent mixing with incoming humid air, with the dry air exiting via the dry air exhaust 103. The dehumidifier 108 includes a vessel 110 having a water outlet 112 and a wet compressed air inlet 114. A weak desiccant cooling line 116 passes through the vessel 110 of the dehumidifier 108 and conveys the weak desiccant to a humidifier 120. The wet compressed air inlet 114 allows wet compressed air to pass over the weak desiccant cooling line 116. Herein, the wet compressed air is cooled through exposure to the weak desiccant cooling line 116, producing dry pressurized air and condensed water. Herein, the vessel 110 is configured with internal heat exchange surfaces, where the weak desiccant solution serves as a cooling medium while flowing through the weak desiccant cooling line 116. Simultaneously, wet compressed air entering through the wet compressed air inlet 114 contacts the cooling surfaces, resulting in condensation of water vapor, which is collected via the water outlet 112. The water outlet 112 conveys the condensed water to a freshwater storage tank 118.

Further, in the system 100, a dry pressurized air line 122 connects the vessel 110 of the dehumidifier 108 to a body 124 of the humidifier 120. The dry pressurized air exits the vessel 110 of the dehumidifier 108 through the dry pressurized air line 122. A throttle valve 126 is disposed in line with the dry pressurized air line 122 downstream from the dehumidifier 108 and upstream from the humidifier 120. The throttle valve 126 is configured to allow the dry pressurized air from the dehumidifier 108 to flow into the humidifier 120, thereby introducing dry air into the humidifier 120. Herein, the use of the throttle valve 126 leads to the dry air being introduced into the humidifier at a controlled pressure. The pressure reduction through the throttle valve 126 contributes to the variable pressure operation of the system 100.

Also, as illustrated, the humidifier 120 comprises the body 124, a strong desiccant outlet 128, and a wet air outlet 130. Herein, the dry air is exposed to weak desiccant to produce wet air and strong desiccant. Specifically, within the body 124 of the humidifier 120, the dry air contacts the weak desiccant to produce the wet air and the strong desiccant. The body 124 of the humidifier 120 may employ structured packing material to facilitate mass transfer between the dry air and weak desiccant through a counter-current flow arrangement. The packing material creates extended surface area for contact between the fluid streams, such that the weak desiccant flows downward while the dry air flows upward through the body 124. The strong desiccant outlet 128 removes concentrated desiccant solution following moisture extraction from the air stream, while the wet air outlet 130 discharges moisturized air with elevated humidity ratio. The process within the body 124 operates under sub-atmospheric pressure conditions to enhance vapor absorption into the desiccant solution. The wet air from the humidifier 120 is fed through the wet air outlet 130 to a compressor line 132. Further, the strong desiccant is conveyed to the desiccant-based moisture extractor 104 through a strong desiccant line 134.

A compressor 136 sits in line with the compressor line 132 and compresses the wet air to form wet compressed air. Herein, the wet compressed air is fed to the wet compressed air inlet 114 of the dehumidifier 108. The compressor 136 provides mechanical work to increase both pressure and temperature of the wet air stream through adiabatic compression process. The compression ratio of the compressor 136 is maintained within operational limits to achieve desired pressure elevation while managing temperature rise. The mass flow rate through the compressor 136 is regulated based on pressure conditions within the humidifier 120, in which higher humidifier pressures require correspondingly higher compression work to maintain the pressure differential across the system 100.

According to embodiments of the present disclosure, in the system 100, the dehumidifier 108, the dry pressurized air line 122, the humidifier 120, and the compressor line 132 form a closed gas loop. Further, the weak desiccant line 106, the weak desiccant cooling line 116, the strong desiccant line 134, and the desiccant-based moisture extractor 104 form a closed desiccant loop. The closed gas loop enables continuous circulation of process air through sequential pressure and temperature modifications to facilitate water vapor transport. The dehumidifier 108 operates at elevated pressure relative to the humidifier 120, creating driving force for vapor condensation. The dry pressurized air line 122 maintains thermal isolation to preserve the temperature gradient required for effective mass transfer. The closed desiccant loop circulates lithium chloride solution through concentration cycles, wherein dilute solution from moisture absorption is continuously regenerated through the thermal-pressure cycle. The weak desiccant cooling line 116 facilitates heat removal from the compressed air stream while preheating the desiccant solution for subsequent regeneration.

In present embodiments, the system 100 employs lithium chloride as the desiccant material within both the closed gas loop and the closed desiccant loop. The concentration of lithium chloride varies between strong and weak states as the desiccant cycles through the system 100, with concentration values ranging from 30 to 40 weight percent lithium chloride. The strong desiccant maintains higher concentration levels suitable for moisture extraction in the desiccant-based moisture extractor 104, while the weak desiccant exhibits reduced concentration due to absorbed moisture content.

Further, in the system 100, the air intake 102 may have a ducted inlet configuration designed to optimize atmospheric moisture collection under varying humidity conditions ranging from 80% to 100% relative humidity. The air intake 102 incorporates airflow management features to maintain consistent inlet conditions, with the intake positioned to utilize prevailing wind patterns for enhanced humid air collection. A desiccant tank 140 (as illustrated in FIG. 1) is configured to store and supply the desiccant solution. The desiccant tank 140 may include a cylindrical vessel with multiple inlet and outlet ports to facilitate desiccant circulation. The capacity of the desiccant tank 140 is sized to maintain sufficient desiccant for continuous operation while accommodating concentration variations between strong and weak desiccant states.

Furthermore, in the system 100, a pump 142 is disposed in line with the weak desiccant line 106 between the desiccant tank 140 and the desiccant-based moisture extractor 104. The pump 142 circulates desiccant solution through the closed desiccant loop at controlled flow rates optimized for moisture extraction and regeneration processes. The pump 142 maintains desiccant mass flow rates corresponding to mass ratio values ranging from 0.5 to 2.5, depending on operational conditions. The desiccant flow rate through the pump 142 varies with humidifier pressure conditions, with lower humidifier pressures requiring increased desiccant circulation to maintain optimal moisture extraction performance. In an exemplary configuration, the desiccant-based moisture extractor 104 utilizes packed bed configuration. These packing material parameters enable effective contact between the humid air from the air intake 102 and the strong desiccant supplied from the desiccant tank 140 through the pump 142.

As discussed and also shown in FIG. 1, the dehumidifier 108, the dry pressurized air line 122, the humidifier 120, and the compressor line 132 form a closed gas loop in the system 100. Herein, the desiccant flows through discrete operational states. The weak desiccant in state d,1 enters the weak desiccant cooling line 116 within the vessel 110 of the dehumidifier 108. The dry pressurized air in state a,1 exits the vessel 110 of the dehumidifier 108 and flows through the throttle valve 126. The throttle valve 126 reduces the pressure of the dry pressurized air to achieve state a,2. The pressure reduction within the throttle valve 126 produces condensed water, which flows to the freshwater storage tank 118.

Also, as shown in FIG. 1, the weak desiccant exits the vessel 110 of the dehumidifier 108 in state d,2 and flows through the weak desiccant cooling line 116 to the body 124 of the humidifier 120. The humidifier 120 comprises an array of spray nozzles 121 configured within the body 124. The spray nozzles 121 distribute the weak desiccant to contact the dry pressurized air. The desiccant exits the body 124 of the humidifier 120 in state d,3 through the strong desiccant outlet 128. A pump 138 is disposed in line with the strong desiccant line 134 between the humidifier 120 and the desiccant-based moisture extractor 104, which is configured to convey the strong desiccant to the desiccant-based moisture extractor 104.

Further, the desiccant-based moisture extractor 104 includes an array of distribution nozzles 107 configured to spray the strong desiccant for contact with humid air entering through the air intake 102. It may be noted that the humid air enters the desiccant-based moisture extractor 104 in state a,5 through the air intake 102, such that the humid air contacts the strong desiccant distributed by the distribution nozzles 107. The contact between the humid air and the strong desiccant produces the dry air output in state a,6 and weak desiccant. This dry air output flows through the designated flow path away from the air intake 102, while the weak desiccant flows through the weak desiccant line 106 to continue the cycle.

In a preferred embodiment, the humidifier 120 contains a plurality of layers of different spray nozzles each layer providing a desiccant spray of different average particle size. Preferably, a first level of spray nozzles disposed within the top ¼ of the height of the humidifier 120, representing the lowest row of spray nozzles of a plurality of layers of spray nozzles, provides a spray of weak desiccant having the largest particle size, preferably a particle size that is at least twice the particle size of any subsequent layer of spray nozzles. A second layer of spray nozzles positioned above the first layer of spray nozzles provides a second spray of the weak desiccant, with the second spray having an average particle size smaller than the average particle size of the first layer. Additional layers of spray nozzles, preferably including a third layer of spray nozzles providing a spray having an average particle size that is ¼ or less the average particle size of the spray from the first layer of spray nozzles, is present in the humidifier. The distance between layers is approximately 10% of the height of the humidifier measured from an inside base of the humidifier to an inside uppermost point of the humidifier. The inclusion of a plurality of layers of spray nozzles of successively smaller particle spray size provides effective humidification while minimizing particle carryover into the outlet 103 of the humidifier.

Furthermore, in the system 100, the dry pressurized air in the state a,2 enters the body 124 of the humidifier 120 through the dry pressurized air line 122. Within the body 124 of the humidifier 120, the dry pressurized air contacts the weak desiccant to produce wet air in state a,3. The wet air exits the humidifier 120 through the wet air outlet 130 and flows through the compressor line 132 to the compressor 136. The compressor 136 increases the pressure and temperature of the wet air to achieve state a,4. Further, the wet compressed air flows to the wet compressed air inlet 114 of the dehumidifier 108.

Within the vessel 110 of the dehumidifier 108, the wet compressed air flows over the weak desiccant cooling line 116. The wet compressed air transfers heat to the weak desiccant flowing through the weak desiccant cooling line 116, while the wet compressed air is cooled and condensed to produce dry pressurized air in state a, 1 and condensed water. The condensed water exits the vessel 110 through the water outlet 112 to the freshwater storage tank 118. The dry air output from the desiccant-based moisture extractor 104 flows through a designated flow path incorporating flow deflectors positioned to prevent the dry air output from mixing with humid air entering the air intake 102. The flow path maintains separation between the dry air output and the air intake 102 through directional control and positioning of the desiccant-based moisture extractor 104 relative to prevailing atmospheric air flow patterns.

The system 100 of the present disclosure operates with defined pressure ratios between the humidifier 120 and the dehumidifier 108 to optimize performance. The system 100 achieves specific performance metrics (such as Gain Output Ratio, recovery ratio, total freshwater production, etc.) when operated at different pressure ratios with different effectiveness parameters, that further vary with humidifier pressure. The gain output ratio (GOR) is characterized as the proportion between the latent heat of vaporization for freshwater and the aggregate energy consumed to produce this freshwater. Recovery ratio (RR) is defined as the ratio of fresh water produced to the inlet desiccant solution. In the present configuration of the system 100, the Gain Output Ratio increases as humidifier pressure decreases. The recovery ratio of the system 100 also demonstrates similar pressure-dependent behavior. Total freshwater production of the system, which is defined as the water mass flow rate in kg·s⁻¹, also varies with humidifier pressure.

Generally, in present embodiments, the Gain Output Ratio is greater than or equal to 1.75, preferably 2.00. In particular, the Gain Output Ratio is greater than or equal to 2.20. Specifically, in present embodiments, the Gain Output Ratio is greater than or equal to 1.05, preferably 1.20 when operated at a pressure ratio of 1.4, assuming an effectiveness parameter of 0.7, and wherein a pressure of the humidifier is 80 kPa. The Gain Output Ratio is greater than or equal to 1.2, preferably 1.30 when operated at a pressure ratio of 1.4, assuming an effectiveness parameter of 0.7, and wherein a pressure of the humidifier is 70 kPa. The Gain Output Ratio is greater than or equal to 1.27, preferably 1.37 when operated at a pressure ratio of 1.4, assuming an effectiveness parameter of 0.7, and wherein a pressure of the humidifier is 60 kPa. The Gain Output Ratio is greater than or equal to 1.37, preferably 1.47 when operated at a pressure ratio of 1.4, assuming an effectiveness parameter of 0.7, and wherein a pressure of the humidifier is 50 kPa. The Gain Output Ratio is greater than or equal to 1.5, preferably 1.60 when operated at a pressure ratio of 1.4, assuming an effectiveness parameter of 0.7, and wherein a pressure of the humidifier is 40 kPa. That is, at a humidifier pressure of 80 kPa, the Gain Output Ratio is greater than or equal to 1.20, and the Gain Output Ratio increases as humidifier pressure decreases, reaching values greater than or equal to 1.30 at 70 kPa, greater than or equal to 1.37 at 60 kPa, greater than or equal to 1.47 at 50 kPa, and greater than or equal to 1.60 at 40 kPa.

Further, generally, the recovery ratio is greater than or equal to 1.75, preferably 2.00. In particular, the recovery ratio is greater than or equal to 2.40. Specifically, in present embodiments, recovery ratio is greater than or equal to 1.9, preferably 2.00 when operated at a pressure ratio of 1.4, assuming an effectiveness parameter of 0.7, and wherein a pressure of the humidifier is 80 kPa. The recovery ratio is greater than or equal to 1.975, preferably 2.075, when operated at a pressure ratio of 1.4, assuming an effectiveness parameter of 0.7, and wherein a pressure of the humidifier is 70 kPa. The recovery ratio is greater than or equal to 2.05, preferably 2.15 when operated at a pressure ratio of 1.4, assuming an effectiveness parameter of 0.7, and wherein a pressure of the humidifier is 60 kPa. The recovery ratio is greater than or equal to 2.10, preferably 2.20 when operated at a pressure ratio of 1.4, assuming an effectiveness parameter of 0.7, and wherein a pressure of the humidifier is 50 kPa. The recovery ratio is greater than or equal to 2.20, preferably 2.30, when operated at a pressure ratio of 1.4, assuming an effectiveness parameter of 0.7, and wherein a pressure of the humidifier is 40 kPa.

Furthermore, in present embodiments, the total freshwater production is greater than or equal to a water mass flow rate of 15×10⁻³ kg·s⁻¹, preferably 20×10⁻³ kg·s⁻¹ when operated at a pressure ratio of 1.4, assuming an effectiveness parameter of 0.7, and wherein a pressure of the humidifier is 80 kPa. The total freshwater production is greater than or equal to a water mass flow rate of 15.8×10⁻³ kg·s⁻¹, preferably 20.8×10⁻³ kg·s⁻¹ when operated at a pressure ratio of 1.4, assuming an effectiveness parameter of 0.7, and wherein a pressure of the humidifier is 70 kPa. The total freshwater production is greater than or equal to a water mass flow rate of 16.5×10⁻³ kg·s⁻¹, preferably 21.5×10⁻³ kg·s⁻¹ when operated at a pressure ratio of 1.4, assuming an effectiveness parameter of 0.7, and wherein a pressure of the humidifier is 60 kPa. The total freshwater production is greater than or equal to a water mass flow rate of 17×10⁻³ kg·s⁻¹, preferably 22.0×10⁻³ kg·s⁻¹ when operated at a pressure ratio of 1.4, assuming an effectiveness parameter of 0.7, and wherein a pressure of the humidifier is 50 kPa.

The next section outlines the methodology used to evaluate the performance of the system 100, focusing on metrics such as Gain Output Ratio (GOR), Mass Flow Rate Ratio (MR), and Recovery Ratio (RR). The proceeding paragraphs details the mathematical modeling of the desiccant-based moisture extractor and variable pressure humidification-dehumidification system, emphasizing mass and energy balance equations under steady-state conditions and minimal heat losses. The effectiveness of heat and mass transfer within the system 100 is explored through specific formulas, assessing factors that influence these processes. Validation of the model against experimental and theoretical data from the literature confirms its accuracy. The following nomenclature has been utilized for purposes of the present disclosure.

### Nomenclature

### Acronyms

CAOD closed-air open-desiccant
HDH humidification dehumidification

### Symbol

A area
aₜ specific surface area of the packing material
Cₚ constant pressure specific heat capacity (kJ kg_{d}⁻¹)
F flux (kg s⁻¹ m⁻²)
GOR gain-output ratio
H total enthalpy (kJ)
h specific enthalpy (kJ kg_{d}⁻¹)
h_{fg} evaporation latent heat (kJ kg_{d}⁻¹)
mass flow rate (kg s⁻¹)
Me Merkel number
MR desiccant-to-air mass flow rate ratio
NTU number of transfer units
RR recovery ratio
S desiccant concentration (%)
T temperature (° C.)
\dot{W} Power (W)
Z height of the packing material

### Greek

Δ difference
γ surface tension
ε energy effectiveness
ζ arbitrary factors
ω humidity ratio (kg_{H2O} kg⁻¹_{d})

### Subscripts

a air
av average
CP compressor Power
cr critical
d desiccant
deh dehumidifier
fw freshwater
hum humidifier
id ideal
in inlet
max maximum
me moisture extractor
min minimum
out outlet
Th throttle

The present disclosure encompasses a comprehensive overview of open literature, as systematically tabulated in Table 1, with review of research on expanders and compressors, including Iglesias and Favrat [See: Iglesias A, Favrat D. Innovative isothermal oil-free co-rotating scroll compressor-expander for energy storage with first expander tests. Energy Convers, Manag 2014; 85:565-72, incorporated herein by reference in its entirety]; Ko et al. [See: Ko Y, Park S, Jin S, Kim B, Jeong J H. The selection of volume ratio of two-stage rotary compressor and its effects on air-to-water heat pump with flash tank cycle. Appl Energy, 2013; 104:187-96, incorporated herein by reference in its entirety]; and Hou and Zhang [See: Hou S, Zhang H. An open reversed Brayton cycle with regeneration using moist air for deep freeze cooled by circulating water. Int J Therm Sci, 2009; 48:218-23, incorporated herein by reference in its entirety].

The present disclosure encompasses a comprehensive overview of open literature, as systematically tabulated in Table 1 (below). It is underscored within this compilation that using a rotary compressor emerges as an optimal choice for the current Humidification-Dehumidification (HDH) configuration. This preference is attributed to its favorable pressure ratio, which aligns well with the specifications of the system 100 being studied.

TABLE 1
Review of Research on Expanders and Compressors.

| Authors | Scope | Results |
|---|---|---|
| Iglesias | Investigation of | Their compressor-expander achieved |
| and Favrat | an isothermal | a pressure of 4.5 bar, operating |
| | scroll compressor- | at a rotational speed of 8,000- |
| | expander. | 10,000 RPM, and demonstrated an |
| | | efficiency range between 70-75%. |
| Ko et al. | Analyzing the | Their analysis revealed enhanced |
| | performance | efficiency of the twin rotary |
| | differences between | system at lower frequencies and |
| | twin rotary and two- | better adaptability for operations |
| | stage rotary systems. | at low temperatures. |
| Hou and | Exploring the | In their study, the axial compressor |
| Zhang | use of an axial | showed a pressure ratio between |
| | compressor within | 2 and 3.5. They also noted the |
| | the Brayton cycle. | capability to regulate the mass |
| | | flow rate, pressure ratio, and |
| | | refrigerant capacity through the |
| | | adjustment of rotational speed. |

While a substantial portion of the existing scholarly discourse is centered on HDH systems functioning at standard atmospheric conditions, the present disclosure diverges by investigating the system 100 engineered to operate at sub-atmospheric pressures, thereby potentially augmenting the efficiency of the humidification component. This exploration entails a thorough description of mathematical formulation for the system 100. Subsequently, an analysis anchored in the principles of the first law of thermodynamics is conducted, taking into account a set of predefined operational parameters. The system 100 is analyzed based on the following performance parameters:

### Gain Output Ratio

The gained output ratio (GOR) serves to offer a detailed insight into the performance of the system in question. It is characterized as the proportion between the latent heat of vaporization for freshwater and the aggregate energy consumed to produce this freshwater. The GOR is articulated as follows [See: Sharqawy M H, Antar M A, Zubair S M, Elbashir A M. Optimum thermal design of humidification dehumidification desalination systems. Desalination, 2014; 349:10-21, incorporated herein by reference in its entirety].

$$GOR = \frac{{\dot{m}}_{fw} {h}_{fg}}{{\dot{W}}_{CP}} \qquad ( ( 1 )$$

### Mass Flow Rate Ratio

Mass flow rate ratio (MR) is defined as the ratio of the desiccant solution to air mass flow rates,

$$MR = \frac{{\dot{m}}_{d}}{{\dot{m}}_{a}} \qquad ( ( 2 )$$

### Recovery Ratio

Recovery ratio (RR) is defined as the ratio of fresh water produced to the inlet desiccant solution,

$$RR = \frac{{\dot{m}}_{fw}}{{\dot{m}}_{d}} \times 100 \% \qquad ( ( 3 )$$

For the mathematical modeling of the system, mass and energy balance equations are applied to each component. The model is based on several assumptions: all cycles within the system operate in a steady state; lithium chloride is chosen for its strong affinity (hygroscopicity) for absorbing water vapor from humid air; heat losses from any of the system's components are considered negligible; the power required for pumping is disregarded when compared to the compressor energy involved; contributions from kinetic and potential energies are excluded. In the moisture extraction process, heat and mass are concurrently transferred. The operative force within this apparatus stems from the variance in water vapor pressure between the desiccant and the air at the interface where heat and mass exchange occur. The condition at this interface is influenced by the temperature and concentration of the liquid desiccant, as well as the humidity and temperature of the air.

This section outlines the conservation equations pertinent to the moisture extractor within the proposed system, as referenced in [See: Martin V, Goswami D Y. Effectiveness of heat and mass transfer processes in a packed bed liquid desiccant dehumidifier/regenerator. HVAC& R Res, 2000; 6:21-39, incorporated herein by reference in its entirety]. The relevant states are depicted in FIG. 1.

$${\dot{m}}_{d , 3} + {\dot{m}}_{a , me} ( {ω}_{a , 5} - {ω}_{a , 6} ) = {\dot{m}}_{d , 1} \qquad ( ( 4 )$$

$${\dot{m}}_{d , 3} {h}_{d , 3} - {\dot{m}}_{d , 1} {h}_{d , 1} = {\dot{m}}_{a , me} ( {h}_{a , 6} - {h}_{a , 5} ) \qquad ( ( 5 )$$

$$( 1 - {ζ}_{d , 3} ) {\dot{m}}_{d , 3} + {\dot{m}}_{a , me} ( {ω}_{a , 5} - {ω}_{a , 6} ) = ( 1 - {ζ}_{d , 1} ) {\dot{m}}_{d , 1} \qquad ( ( 6 )$$

The equation set presented above is indeterminate due to the presence of two unknown parameters. Therefore, to facilitate the resolution of these equations, the effectiveness of the packed-bed moisture extractor in terms of heat and mass transfer is specified.

Within the moisture extractor, the capacity for energy transfer depends on the variance in temperature and concentration. The concept of effectiveness for energy is based on the greatest possible enthalpy difference in the air, achievable in a heat and mass exchanger operating at full effectiveness. This is formalized in Equation (7) below [See: Narayan G P, Mistry K H, Sharqawy MH, Zubair S M, Lienhard J H. Energy effectiveness of simultaneous heat and mass exchange devices. Front Heat Mass Transf, 2010; 1, incorporated herein by reference in its entirety].

$${ε}_{ht , me} = \frac{Δ {\dot{H}}_{a}}{Δ {\dot{H}}_{a , max}} = \frac{( {h}_{a , in} - {h}_{a , out} )}{( {h}_{a , in} - {h}_{a , out , id} )} \qquad ( ( 7 )$$

where h_{a,out,id} represents the enthalpy of air at the outlet under ideal conditions, achieved when the air temperature equilibrates with the liquid desiccant temperature at the inlet. In such scenarios, the air exits the counter-flow moisture extractor, matching the desiccant's inlet temperature, attaining an ideal humidity ratio. This ratio is determined when the air's water vapor partial pressure minimizes to equal the liquid desiccant's water vapor pressure at the inlet.

Furthermore, in addition to the aforementioned energy effectiveness, the effectiveness related to humidity is also delineated, as expressed in Equation (8) below [See: Martin V and Goswami D Y].

$${ε}_{mt , me} = \frac{( {ω}_{a , in} - {ω}_{a , out} )}{( {ω}_{a , in} - {ω}_{a , out , id} )} \qquad ( ( 8 )$$

As previously discussed, various factors impact the efficiency of packed bed moisture extractors. The parameters influencing the effectiveness in terms of energy and humidity include the dry air mass flow rate, the mass flow rate of the desiccant solution at the inlet of the moisture extractor, the initial specific enthalpy of both air and desiccant solution, the specific surface area and height of the packing material, the surface tension of the desiccant solution at the inlet, and the critical surface tension of the packing material [See: Jain S, Bansal P K. Performance analysis of liquid desiccant dehumidification systems. Int J Refrig, 2007; 30:861-72, incorporated herein by reference in its entirety]. The latter is identified as the highest surface tension value at which the packing material remains completely wetted [See: Rosen M J, Kunjappu J T. Surfactants and interfacial phenomena. John Wiley & Sons; 2012, incorporated herein by reference in its entirety]. Martin and Goswami propose the following functional forms for these correlations.

$${ε}_{mt , me} , {ε}_{ht , me} = 1 - {{C}_{1} ( {\dot{m}}_{d , in} / {\dot{m}}_{a , me} )}^{{k}_{1} ( {γ}_{d , in} / {γ}_{d , cr} ) + {m}_{1}} {( {h}_{a , in} / {h}_{d , in} )}^{{c}_{2}} {( {a}_{t} Z )}^{{k}_{2} ( {γ}_{d , in} / {γ}_{d , cr} ) + {m}_{2}} \qquad ( ( 9 )$$

Martin and Goswami have determined the values of the constants C₁, C₂, k₁, k₂, m₁, m₂ as (48.3, −0.751, 0.396, −1.57, 0.0331, and −0.906) and (3.77, −0.528, 0.289, −1.12, −0.0044, and −0.365), for the humidity and energy effectiveness, respectively, by fitting the correlation presented in Equation (9) utilizing high-precision experimental data [See: Öberg V, Goswami D Y. Experimental Study of the Heat and Mass Transfer in a Packed Bed Liquid Desiccant Air Dehumidifier. J Sol Energy, Eng 1998; 120:289-97, incorporated herein by reference in its entirety].

For reliable application of the mathematical model pertaining to the moisture extractor, the forecasted values are validated against experimental findings documented in scholarly works. Notably, Fumo and Goswami [See: Fumo N, Goswami D Y. Study of an aqueous lithium chloride desiccant system: air dehumidification and desiccant regeneration. Sol Energy, 2002; 72:351-61, incorporated herein by reference in its entirety] provided comprehensive experimental data on the operational performance of a moisture extractor utilizing lithium chloride as the working fluid. In their investigation, the packed-bed moisture extractor featured a fixed height of 0.60 meters. The packing material utilized was 1-inch polypropylene Rauschert Hiflow® rings, characterized by a specific surface area of 210 m²/m³ and a critical surface tension value of 29 N/m [See: Mark J E. Physical Properties of Polymers Handbook. New York: Springer; 2007, incorporated herein by reference in its entirety]. These properties are reflected in the moisture extractor's humidity and energy effectiveness. The moisture extraction rate was assessed considering the impact of various factors, including the desiccant's concentration and temperature, the humidity and temperature of the air, and the flow rates of both the desiccant and air.

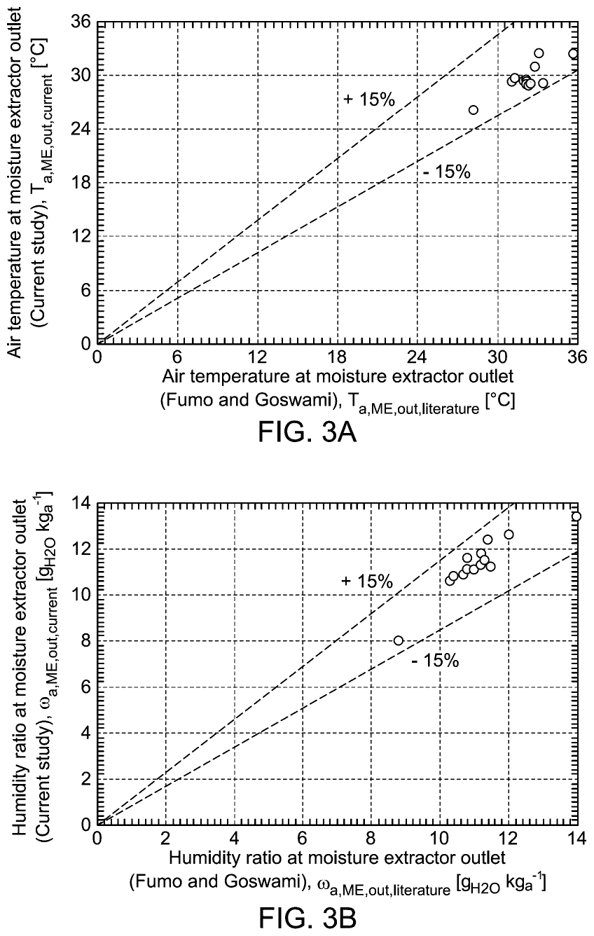

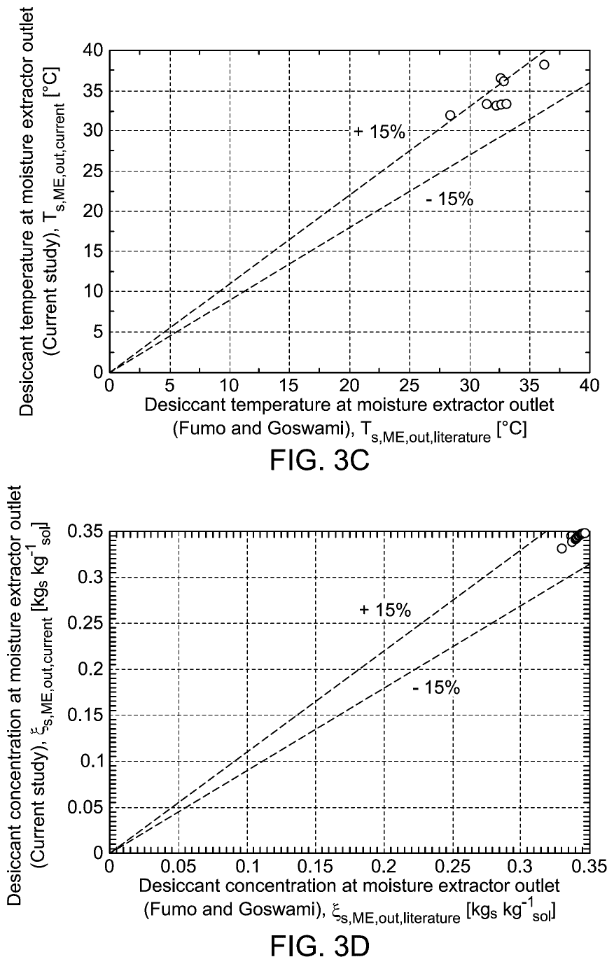

FIGS. 3A-3D present the validation for the moisture extractor, benchmarking it against established experimental data. Each of the graphs in FIGS. 3A-3D correlate different operational parameters. FIG. 3A compares the air temperature at the moisture extractor outlet as predicted by the current study with literature values, demonstrating a discrepancy mostly within ±15%. FIG. 3B shows a similar comparison for the humidity ratio at the moisture extractor outlet, where the data points are tightly clustered along the line of parity within the ±10% range. FIG. 3C contrasts the desiccant temperature at the moisture extractor outlet, and the correlation closely tracks the literature values with acceptable deviation. Finally, FIG. 3D aligns the desiccant concentration at the moisture extractor outlet, where the model's results are compared with experimental data, illustrating a strong agreement. Overall, the model's predictions exhibit remarkable alignment with the experimental data, underscoring its validity. The narrow variance band from 0.2% to 16% reflects the model's capability to accurately simulate the dynamics within the moisture extractor under varying conditions.

The following section examines the variable pressure humidification-dehumidification model, detailing the mass and energy balances that govern its operation. It covers the thermodynamic calculations required for understanding the system's dynamics, such as the condensation process influenced by temperature and pressure changes and the compressor's exit temperature based on pressure ratios. The section also defines the efficiency metrics for the humidifier and dehumidifier. Validation against theoretical data confirms the model's precision, demonstrating its reliability and consistency under varied operational conditions.

The comprehensive mass balance of the HDH side is described in the following manner,

$${\dot{m}}_{d , 3} = {\dot{m}}_{d , 1} - {\dot{m}}_{fw} \qquad ( ( 10 )$$

The freshwater calculation can be represented as follows.

$${\dot{m}}_{fw} = {\dot{m}}_{a , HDH} ( {ω}_{a , 3} - {ω}_{a , 2} ) + {\dot{m}}_{a , HDH} ( {ω}_{a , 2} - {ω}_{a , 1} ) \qquad ( 11 )$$

Freshwater from the throttle (\dot{m}_{a,HDH}(ω_{a,2}−ω_{a,1})) refers to the water produced due to condensation. This condensation results from changes in pressure and temperature experienced by the air as it traverses the throttle valve. The following balances, shown in Eq. 12, account for the mass and energy exchanges occurring within the humidifier.

$${\dot{m}}_{d , 2} \cdot {h}_{d , 2} + {\dot{m}}_{a , HDH} \cdot {h}_{a , 1} = {\dot{m}}_{d , 3} \cdot {h}_{d , 3} + {\dot{m}}_{a , HDH} \cdot {h}_{a , 4} \qquad ( 12 )$$

The mass balance in the dehumidifier focuses on the mass of air and water vapor entering and leaving the unit. It can be represented as.

$${\dot{m}}_{fw , deh} = {\dot{m}}_{a , HDH} ( {ω}_{a , 3} - {ω}_{a , 2} ) \qquad ( 13 )$$

$${\dot{m}}_{d} {h}_{d , 1} + {\dot{m}}_{a , HDH} {h}_{a , 3} = {\dot{m}}_{d , 2} {h}_{d , 2} + {\dot{m}}_{a , HDH} {h}_{a , 2} + {\dot{m}}_{a , HDH} ( {ω}_{a , 3} - {ω}_{a , 2} ) {h}_{fw , deh} \qquad ( 14 )$$

The energy balance for the throttle can be described as follows.

$${\dot{m}}_{a , HDH} {h}_{a , 2} = {\dot{m}}_{a , HDH} {h}_{a , 1} + {\dot{m}}_{a , HDH} ( {ω}_{a , 2} - {ω}_{a , 1} ) {h}_{fw , Th} \qquad ( 15 )$$

The exit temperature of a compressor is computable through the application of the pressure ratio parameter and the properties of the working fluid, typically air. This calculation is based on the thermodynamic principles governing the compression process. For an ideal gas undergoing adiabatic (no heat transfer) and reversible (no entropy generation) compression, the exit temperature can be estimated using the following relationship, derived from the ideal gas law and the concept of adiabatic processes.

$$\frac{{T}_{a , 3}}{{T}_{a , 4}} = {( PR )}^{\frac{k - 1}{k}} \qquad ( 16 )$$

Given that the specific heat ratio (k) for air (assuming it behaves as an ideal gas) is 1.4. The ratio of pressure is determined by comparing the pressure levels in the dehumidifier with those in the humidifier as follows.

$$PR = \frac{{P}_{deh}}{{P}_{hum}} \qquad ( 17 )$$

The efficiency of the humidifier is ascertained by selecting the greater value among the effectiveness associated with the desiccant component and the effectiveness linked to the air component. This is formulated in the following manner.

$${ε}_{hum} = max < \frac{{h}_{a , 4} - {h}_{a , 1}}{{h}_{a , 4 , ideal} - {h}_{a , 1}} , \frac{{h}_{d , 2} - {h}_{d , 3}}{{h}_{d , 2} - {h}_{d , 3 , ideal}} > \qquad ( 18 )$$

In theoretical optimal conditions, it is anticipated that the air discharged from the humidifier (identified as state a,4) will mirror the temperature of the incoming desiccant (referred to as state d,2), simultaneously attaining a relative humidity that hits the saturation mark of 100%. Concurrently, under ideal circumstances, the temperature of the desiccant leaving the humidifier (termed state d,3) aligns with the wet-bulb temperature of the air when it initially enters the humidifier (classified as state a,1).

In a related framework, the performance of the dehumidifier is evaluated by selecting the greater of two metrics: the efficiency linked with either the desiccant or the air aspect, which is defined in the following manner:

$${ε}_{deh} = max < \frac{{h}_{a , 3} - {h}_{a , 2}}{{h}_{a , 3} - {h}_{a , 2 , ideal}} , \frac{{h}_{d , 2} - {h}_{d , 1}}{{h}_{d , 2 , ideal} - {h}_{d , 1}} > \qquad ( 19 )$$

The calculation of the work required by the compressor is formulated as follows.

$${\dot{W}}_{CP} = {\dot{m}}_{a , HDH} ( {h}_{a , 3} - {h}_{a , 4} ) \qquad ( 20 )$$

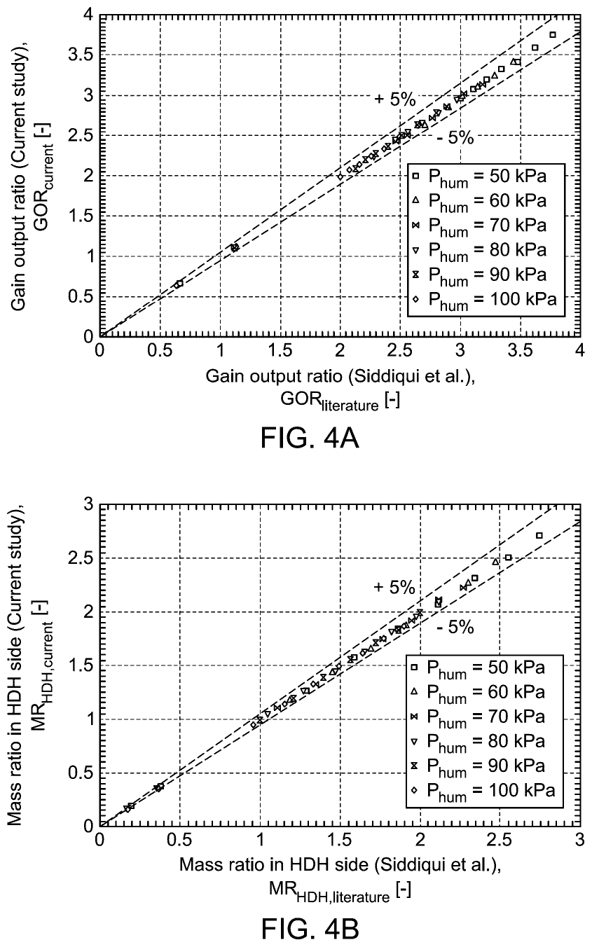

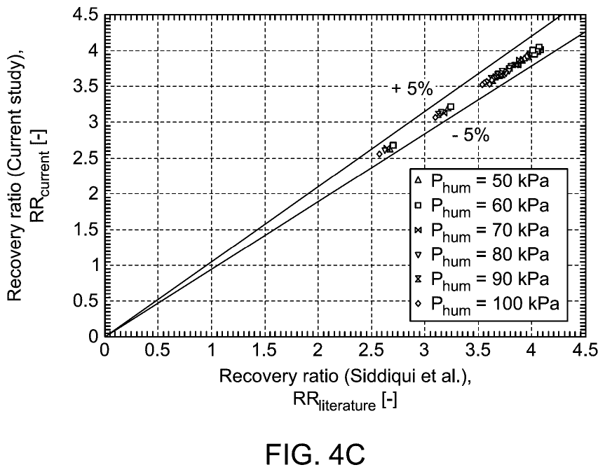

FIGS. 4A-4C encapsulate a trifecta of validations for performance metrics of the HDH side, comparing the Gain Output Ratio (GOR), mass ratio in the HDH side, and recovery ratio against the findings of Siddiqui et al. [See: Siddiqui O K, Sharqawy M H, Antar M A, Zubair S M. Performance evaluation of variable pressure humidification-dehumidification systems. Desalination, 2017; 409:171-82, incorporated herein by reference in its entirety]. The collective insights from FIGS. 4A-4C reflect the current study's alignment with established benchmarks, providing a rigorous endorsement of the model's precision. At an operational effectiveness of 0.8, each metric is assessed, with the resulting data points predominantly situated within the narrow confines of a ±5% deviation from the reference values. The array of data across varying humidifier and dehumidifier pressures further strengthens the validation by demonstrating the model consistency under a range of operational pressures. Despite the inherent variability associated with such comparative analyses, the data points that venture beyond the +5% envelope are both few and negligible.

The following part evaluates the humidifier and dehumidifier's design sizing by using the Merkel method, assuming Lewis's coefficient equals 1 to evaluate the height of the humidifier; the Merkel number is defined as follows [See: Elzayed M S, Ahmed M A M, Qasem N A A, Antar M A, Zubair S M. A design procedure to size thermodynamically-balanced humidification-dehumidification desalination systems. Energy Convers Manag, 2020; 224:113357, incorporated herein by reference in its entirety].

$$Me = {C}_{p , ave} {\int }_{{T}_{d , out}}^{{T}_{d , in}} \frac{{dT}_{d}}{{( {{ζ}_{2} ( {ζ}_{1} {ζ}_{3} - {T}_{d} )}^{- 1} - {ζ}_{3}^{- 1} )}^{{ζ}_{4}^{- 1}} - ( {h}_{a} + {C}_{p , ave} MR ( {T}_{d} - {T}_{d , out} ) )} \qquad ( 21 )$$

where ζ₁=104.4580; ζ₂=117.3950; ζ₃=0.02386, T_{d} is the local seawater temperature, and ha is the saturated air local enthalpy.

The humidifier height varies with the Merkel number and seawater-to-air mass flowrate ratio [See: Bagheri F. Performance investigation of atmospheric water harvesting systems. Water Resour Ind, 2018; 20:23-8, incorporated herein by reference in its entirety],

$${Z}_{hum} = {ζ}_{4} {MR}^{{ζ}_{5}} {Me}^{{ζ}_{6}} \qquad ( 22 )$$

where ζ₄=0.3214; ζ₅=1.5823; ζ₆=1.2326 are arbitrary coefficients (Brentwood manufacturer, CF1200MA) that are a function of the packing material type [See: Sharqawy M H, Antar M A, Zubair S M, Elbashir A M. Optimum thermal design of humidification dehumidification desalination systems. Desalination, 2014; 349:10-21].

The humidifier cross-section area, as in Eq. (23), is estimated utilizing the mass flow rate of seawater with flux.

$${A}_{hum , c} = \frac{{\dot{m}}_{d}}{F} \qquad ( 23 )$$

where A_{hum,c} is the cross-section area of the packing material; F is seawater flux over the humidifier packing material.

The dehumidifier's total surface area is estimated using the effectiveness-number of transfer units method. The dehumidifier's effectiveness depends on the number of transfer units and heat capacity ratio as shown in Eq. (24),

$${ε}_{deh} = 1 - {e}^{- ( 1 + C ) NTU} {( {I}_{0} + \sqrt{C} {I}_{1} - \frac{1 - C}{C} {\sum }_{i = 2}^{∞} {C}^{i / 2} {I}_{i} )}_{i} \qquad ( 24 )$$

where Iᵢ denotes the i^{th}-order Bessel function and is estimated at 2NTU\sqrt{C}, and C can be expressed as,

$$C = \frac{{\dot{m}}_{a} {C}_{p , a}}{{\dot{m}}_{d} {C}_{p , d}} \qquad ( 25 )$$

Based on Eqs. 24-25, UA of the dehumidifier can be estimated as,

$${( UA )}_{deh} = NTU {\dot{m}}_{a} {C}_{p , a} \qquad ( 26 )$$

The following description is further divided into several sections: Effect of pressure ratio, Effect of desiccant maximum temperature, and Effect of desiccant minimum temperature. Performance metrics such as GOR, MR, and RR are used to evaluate the impact of pressure ratio, desiccant minimum, and desiccant maximum temperatures.

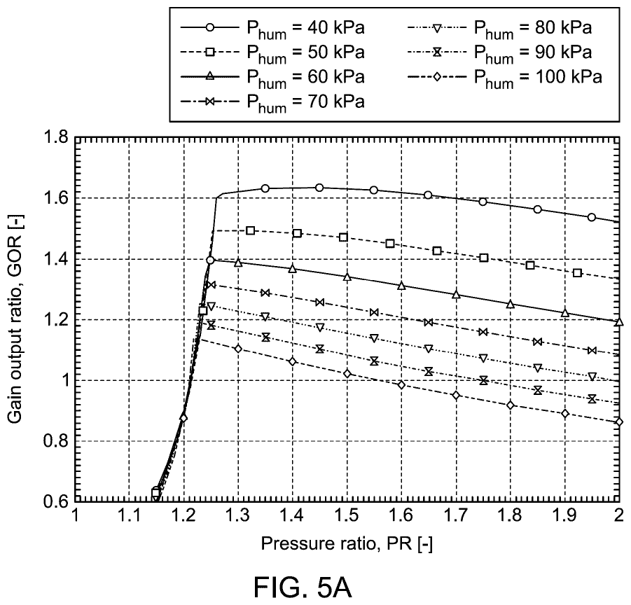

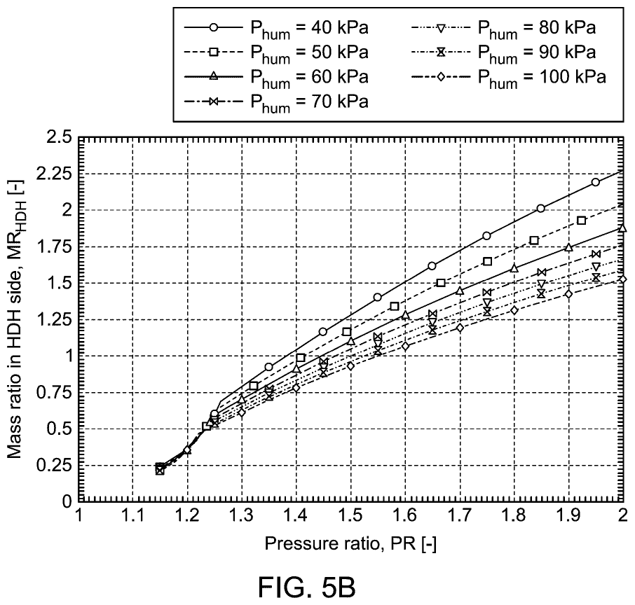

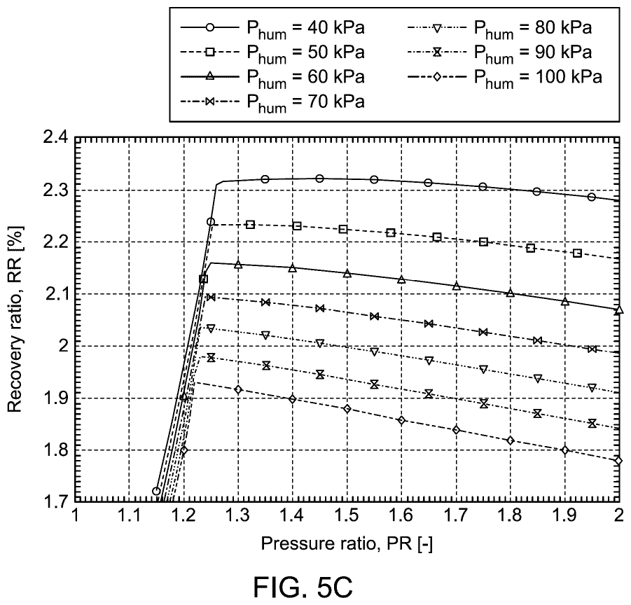

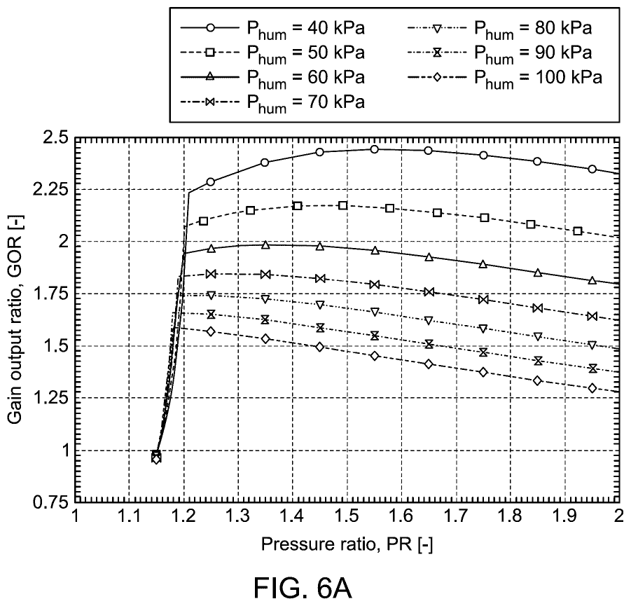

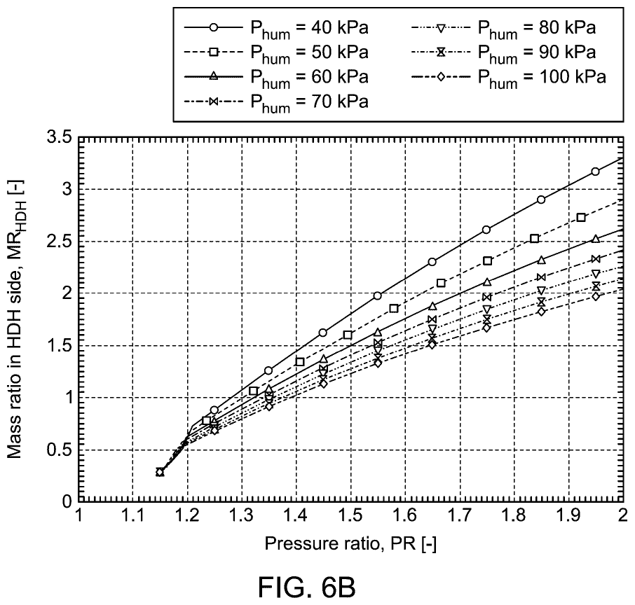

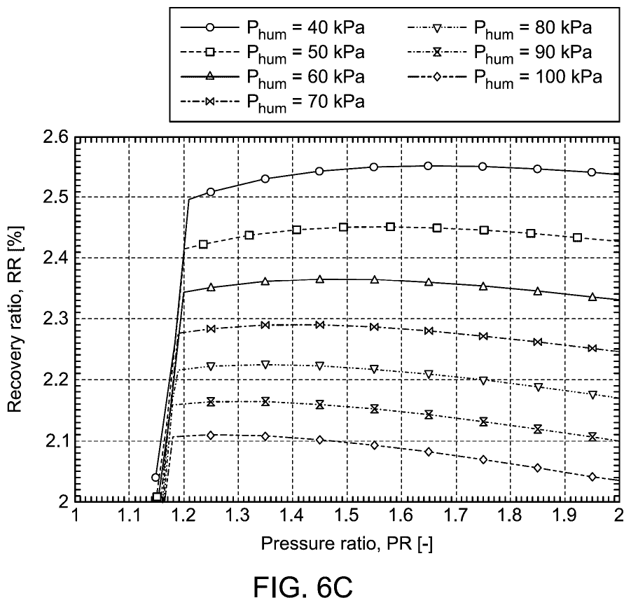

Referring to FIGS. 5A-5C, illustrated are graphs depicting interplay between pressure ratios and various humidifier pressures, all within the framework of an effectiveness parameter set at 0.7. Further, referring to FIGS. 6A-6C, illustrated are graphs depicting interplay between pressure ratios and various humidifier pressures, all within the framework of an effectiveness parameter set at 0.8. Particularly, in FIGS. 5A and 6A, the relationship between the Gain Output Ratio (GOR) and the pressure ratio under varying humidifier pressures is depicted. The effectiveness of the humidifier and dehumidifier is assumed to be 0.7 in FIG. 5A and 0.8 in FIG. 6A. This methodology entails setting a predetermined pressure level within the humidifier and subsequently modifying the pressure ratio to determine the resultant pressure within the dehumidifier. It is observed that a decrease in humidifier pressure leads to a rise in GOR.

This phenomenon is linked to the air's enhanced capacity to hold water vapor at reduced pressures. Concurrently, there is an increase in the workload for the compressor, which theoretically should diminish the GOR. However, the augmentation in freshwater production surpasses the rise in compressor energy consumption, thereby elevating the system's GOR. Notably, varying the pressure ratio reveals an initial rapid increase in GOR across all humidifier pressures, followed by a marked shift to a decreasing trend upon further escalation of the PR. An in-depth analysis of this sudden shift in dynamics suggests its correlation with the previously established concept of effectiveness, which is calculated as the higher value between the water and air side efficiencies in both the humidifier and dehumidifier.

Furthermore, it is noted that increased pressures within the humidifier lead to the attainment of the optimal GOR at comparatively lower PR values. A decline in humidifier pressure results in an increased MR, indicating a higher requirement of desiccant flow rate per unit flowrate of air, as shown in FIGS. 5A and 6A. For both effectiveness settings, the GOR displays a declining trend as the pressure ratio increases. However, when the effectiveness is increased from 0.7 to 0.8, the GOR values are consistently higher across all pressure ratios, indicating a more efficient energy gain from the humidifier system at higher effectiveness. This suggests that the system's energy transfer characteristic is notably sensitive to the effectiveness parameter, with a higher parameter yielding better energy output performance. The decline in GOR with increasing pressure ratio is less steep in the case of higher effectiveness. This demonstrates that the system is better at sustaining its gain output when operating at a more optimal effectiveness level.

Moving to the analysis of the mass flow ratio on the HDH side (MRHDH), FIGS. 5B and 6B illustrate a positive correlation between the pressure ratio and the mass flow ratio for both effectiveness parameters. The incremental nature of the mass flow ratio with respect to the pressure ratio is more pronounced when the system operates at a higher effectiveness of 0.8. This underlines the fact that at higher effectiveness, the system is not only more adept at conserving energy gain, as seen with the GOR, but also at maintaining a higher mass flow rate. The increase in the MRHDH suggests an enhanced transfer of mass within the system, which can be beneficial for processes that require a higher mass throughput at elevated pressure ratios. Therefore, the system's ability to maintain higher mass flow ratios at increased effectiveness could be instrumental for applications demanding greater mass transfer efficiency.

FIGS. 5C and 6C illustrate the variation of the recovery ratio (RR) with PR. Initially, RR surges steeply until the point where the dehumidifier's effectiveness shifts, after which further increments in PR result in an almost constant RR. This observation suggests that the ratio of fresh water generated for each unit of feed water tends to reach a constant value at elevated Pressure Ratio (PR) values. Additionally, with an escalation in the pressure within the humidifier, the Recovery Ratio (RR) experiences a decline. This trend implies a decreased production of water per unit of feed water, attributable to a diminished generation of vapor as a result of the heightened pressure in the humidifier. Moreover, escalating PR enhances freshwater production per unit of airflow (indicated by RR), attributable to increased evaporation as humidifier pressure decreases, thereby allowing for more vapor absorption and, subsequently, greater freshwater output. Also, a rise in PR leads to heightened dehumidifier pressure, contributing to increased freshwater production.

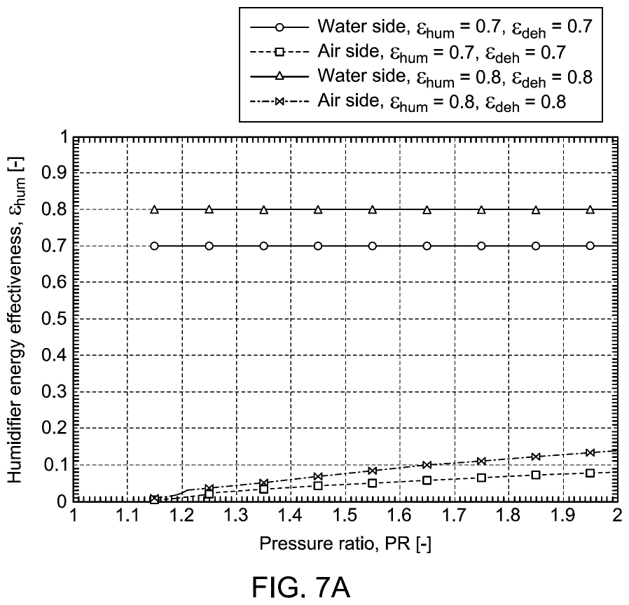

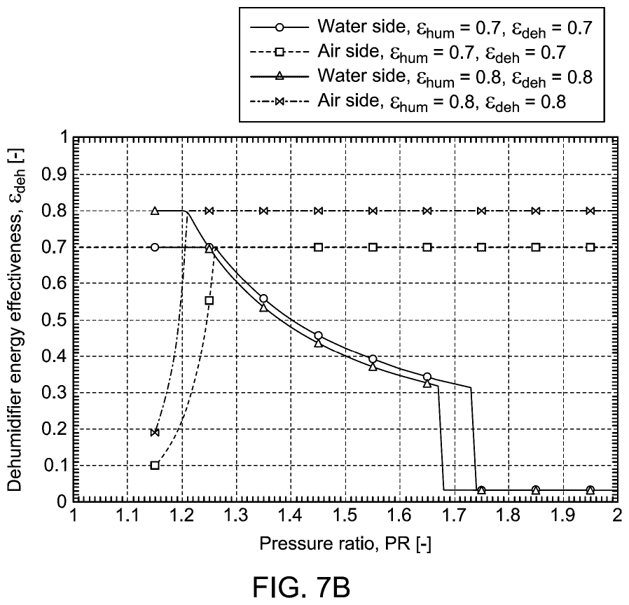

Referring to FIGS. 7A-7B, changes in effectiveness on both the desiccant side and air side are depicted. An in-depth analysis of FIG. 7A reveals that, within the humidifier, the highest level of effectiveness is determined by the change in water enthalpy across the entire range of pressure ratios (PR) under specific operational conditions. The effectiveness attributed to the air side exhibits a consistent upward trend, marked by a notable shift at a PR of around 1.2. This abrupt variation is explained in FIG. 7B, which explains the fluctuating effectiveness of the dehumidifier. During the early phases of reduced pressure ratios (PRs), it was observed that the effectiveness of the waterside was more noticeable. This shift is characterized by the peak effectiveness transitioning from being dominant on the waterside to becoming more prominent on the air side. This transition implies that the water's capacity to contribute to the system's effectiveness reaches its limit, and henceforth, the air stream becomes the more influential factor in the process.

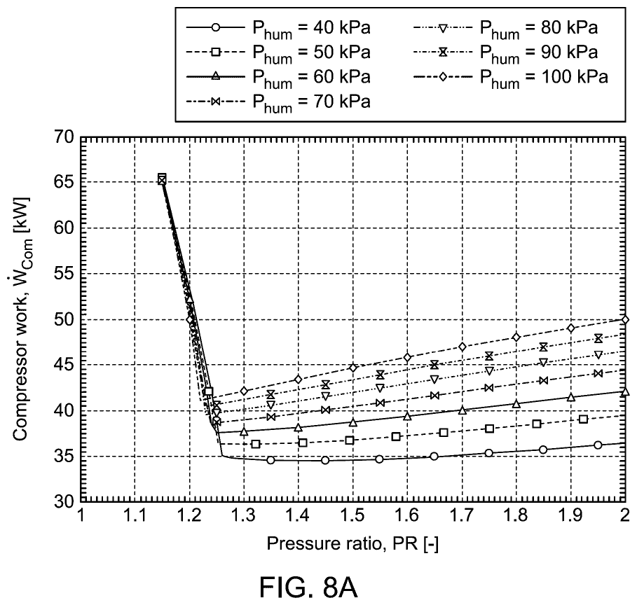

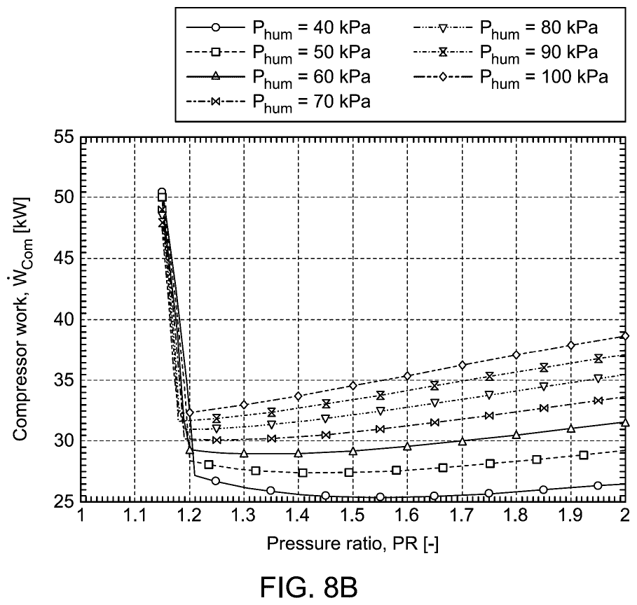

Moreover, the same graphical analysis shows a reduction in waterside effectiveness, particularly at a Pressure Ratio (PR) of 1.68 and 1.75 for effectiveness values of 0.8 and 0.7, respectively. This observed decrease can be linked to the methodology employed in calculating the effectiveness of the dehumidifier. The interplay of these factors creates conditions conducive to water vaporization, which possesses a higher enthalpy, leading to a sudden drop in effectiveness. From a practical standpoint, such conditions should typically be avoided. FIGS. 8A-8B highlight the variation in compressor power across different pressure settings. It becomes evident that an increase in humidifier pressure results in more compressor workload, similar to elevated dehumidifier pressure, determined by the increase in PR, leads to increased compressor work.

Table 2 summarizes the maximum GOR for each effectiveness and the corresponding PR and humidifier pressure. The values of PRₒₚ corresponding to the maximum GOR listed here will be utilized in the next sections to optimize the performance of the system.

TABLE 2
Optimized PR corresponding to different effectiveness.

| | | | | | | | |
|---|---|---|---|---|---|---|---|
| | Pₕᵤₘ = | 50 | 60 | 70 | 80 | 90 | 100 |
| ε [—] | 40 kPa | kPa | kPa | kPa | kPa | kPa | kPa |

Optimum Pressure ratio, PRₒₚ [—]

| | | | | | | | |
|---|---|---|---|---|---|---|---|
| 0.7 | 1.43 | 1.29 | 1.25 | 1.24 | 1.23 | 1.22 | 1.21 |
| 0.8 | 1.56 | 1.46 | 1.37 | 1.29 | 1.22 | 1.18 | 1.16 |

Maximum Gain output ratio, GORₘₐₓ [—]

| | | | | | | | |
|---|---|---|---|---|---|---|---|
| 0.7 | 1.635 | 1.494 | 1.396 | 1.317 | 1.251 | 1.19 | 1.141 |
| 0.8 | 2.441 | 2.172 | 1.984 | 1.846 | 1.741 | 1.659 | 1.587 |

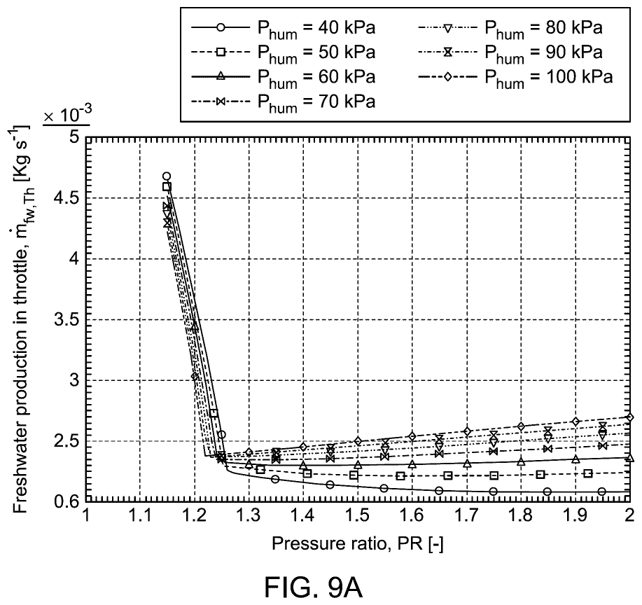

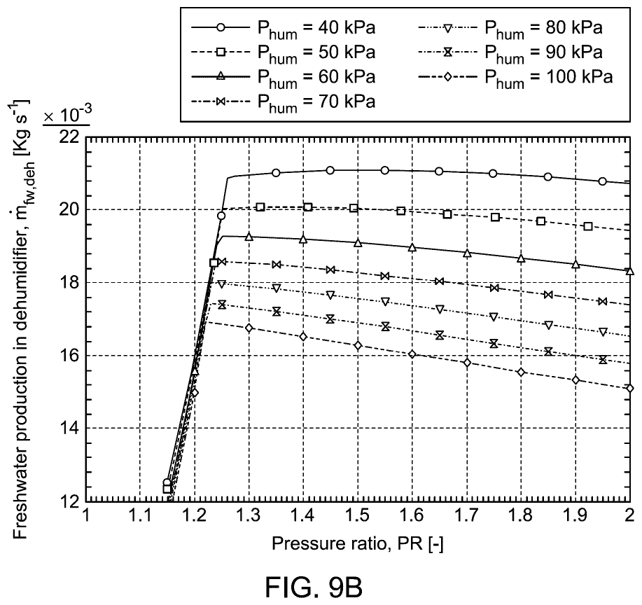

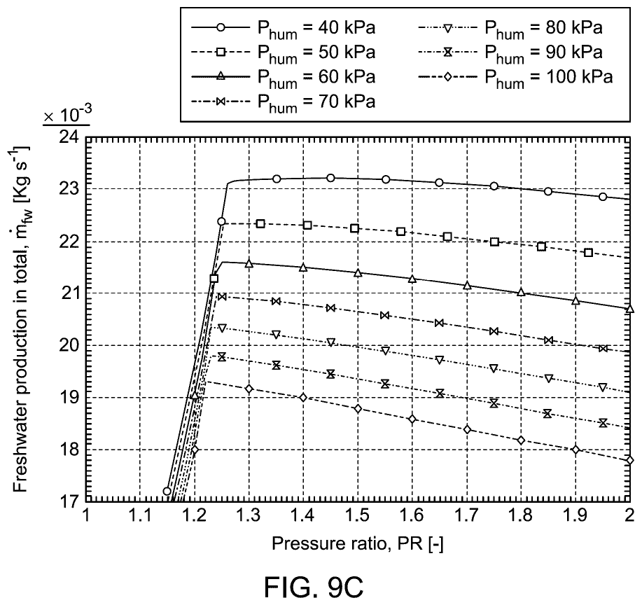

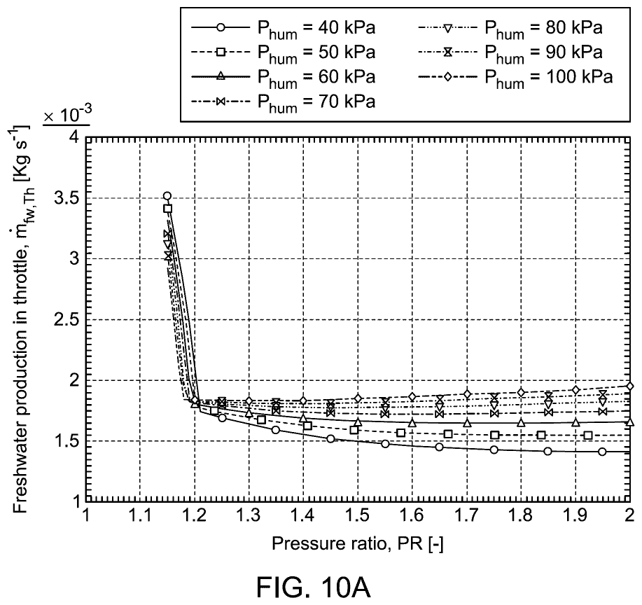

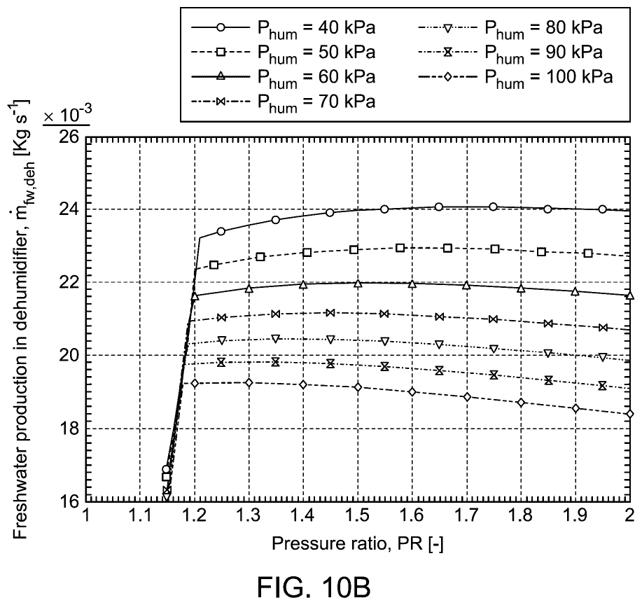

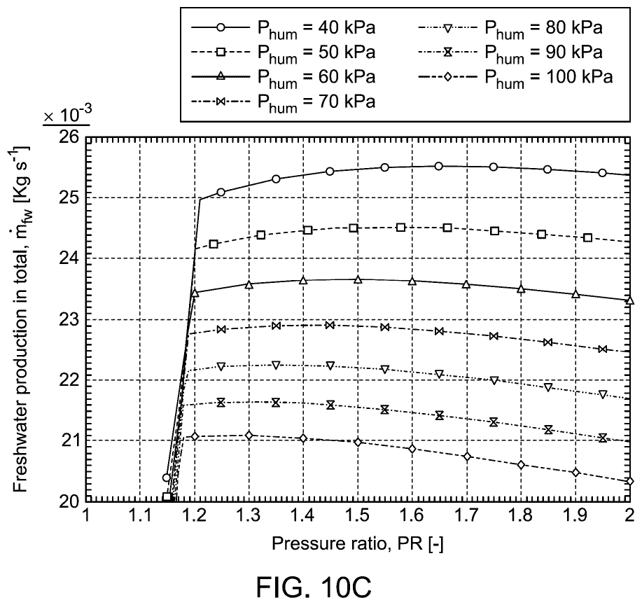

FIGS. 9A-9C and FIGS. 10A-10C offer a comprehensive comparative analysis of freshwater production across varying operational conditions, specifically focusing on different components of the system: the throttle, the dehumidifier, and the system's overall output. Both figures distinctly demonstrate the influence of pressure ratio (PR) and humidification pressure on the performance of each component. Notably, FIGS. 9A-9C, which correspond to an effectiveness of 0.7, reveals that the freshwater production from the throttle shows a sharp decline as the PR increases from 1.15 to approximately 1.25, followed by a gradual trend. This trend is analogously observed in the dehumidifier and total system output, with a reversed direction, although the dehumidifier and total system output present a less steep increase before stabilizing. These trends are consistent across all examined humidification pressures, with the higher pressures generally leading to decreased water production. FIGS. 10A-10C, which reflect an effectiveness of 0.8, show a similar pattern even though at slightly enhanced production rates across all components compared to FIGS. 9A-9C. This increment in effectiveness highlights the system's improved capacity to generate freshwater under elevated operational efficiencies. Both the throttle and dehumidifier components show a pronounced initial drop in production as the PR increases from 1.15 to around 1.20, after which the production stabilizes, indicating a threshold beyond which further increases in PR yield diminishing returns in water output. These insights are beneficial for optimizing the system's operational parameters to maximize freshwater output under different environmental and operational conditions.

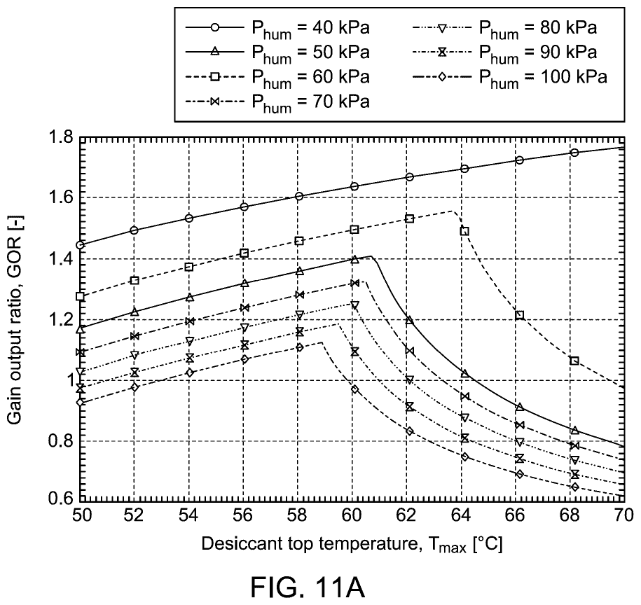

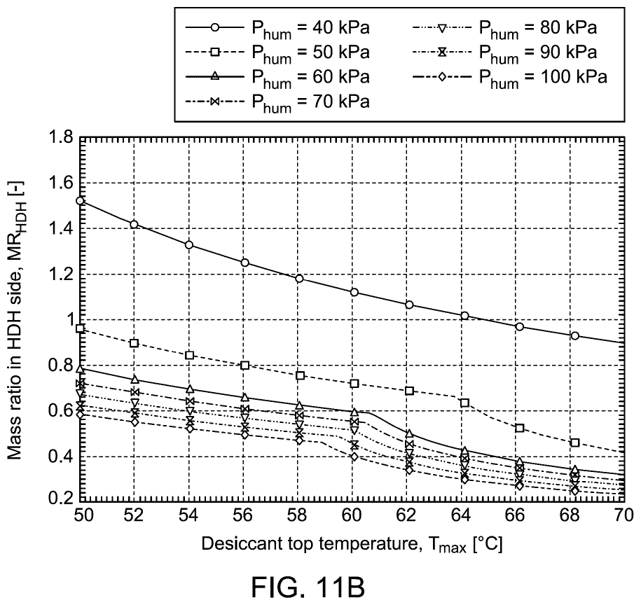

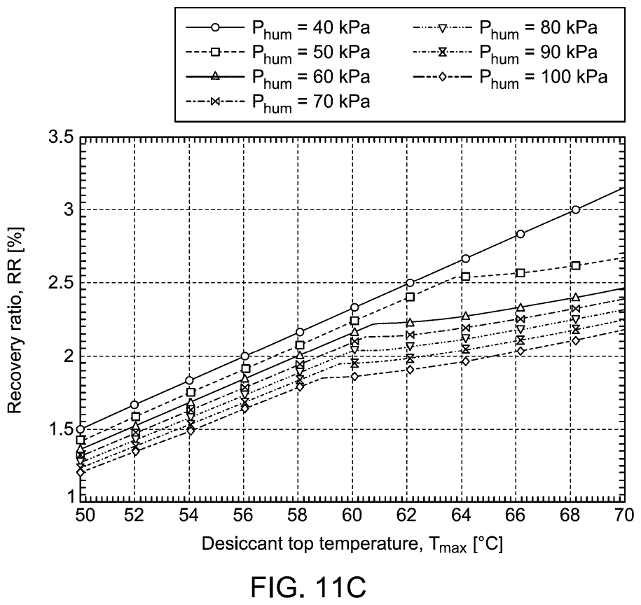

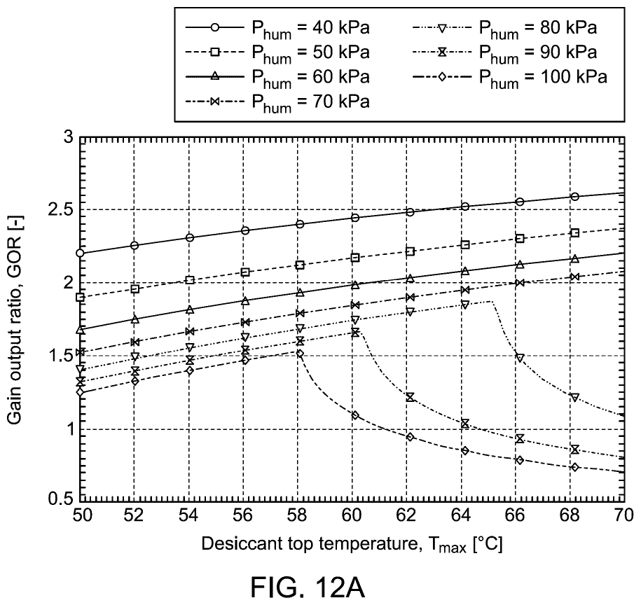

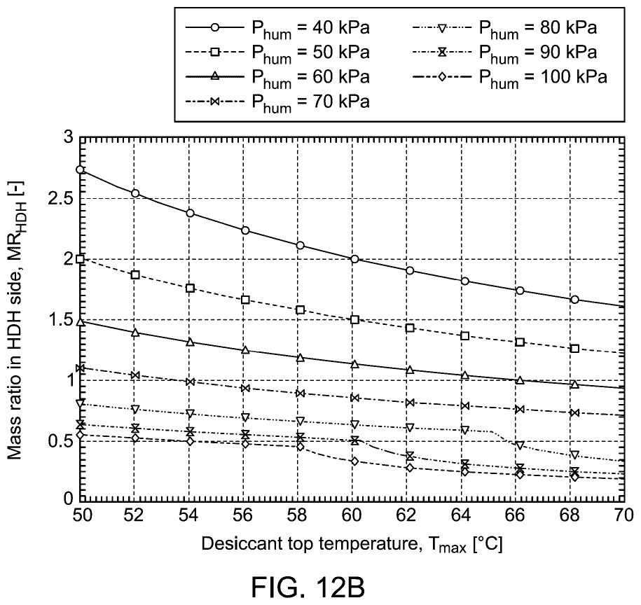

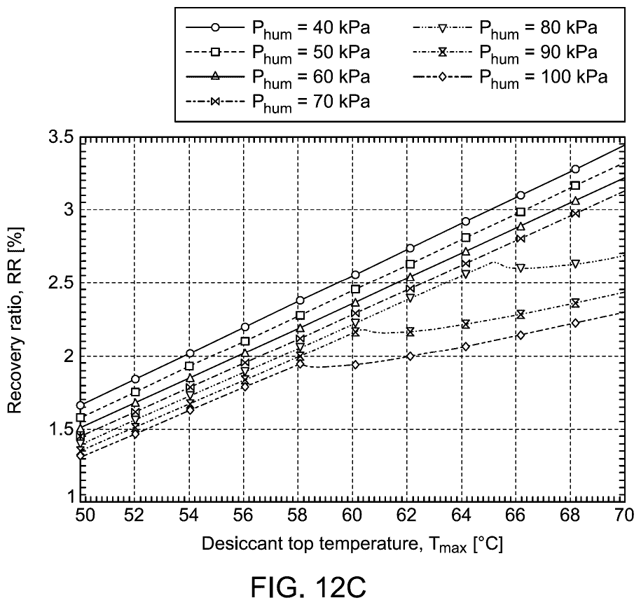

Table 2 lists various maximum GOR values and corresponding optimum PR and humidifier pressure. Using these optimum conditions, the maximum temperature is now varied in this section to obtain the optimized GOR values as depicted in FIGS. 11A-11C and FIGS. 12A-12C. FIGS. 11A and 12A exhibit the behavior of the Gain Output Ratio (GOR) against the desiccant maximum temperature (Tₘₐₓ) at different humid pressures (Pₕᵤₘ) and effectiveness levels of 0.7 and 0.8, respectively. The GOR is a performance metric that typically reflects the efficiency of thermal energy conversion in desiccant systems. For both effectiveness levels, the GOR trends show a peak before declining, indicative of an optimal temperature range for maximum gain. This peak shifts with varying humid pressures, illustrating a complex interplay between pressure, temperature, and the effectiveness of the system. The curves suggest that at an effectiveness of 0.8, the system maintains a higher GOR over a broader temperature range before the decline sets in, which is indicative of improved performance compared to an effectiveness of 0.7.

In the analysis of FIGS. 11B and 12B, the mass ratio in the HDH Side is plotted against Tₘₐₓ for various Pₕᵤₘ values at the two different levels of effectiveness. The mass ratio, which influences the capacity of the desiccant system for moisture removal, declines with an increase in Tₘₐₓ for all the pressure scenarios considered. Notably, at an effectiveness of 0.8, the mass ratio maintains higher values across the temperature range compared to an effectiveness of 0.7, suggesting that the desiccant system operates with greater moisture handling efficiency at the higher effectiveness level. The consistency of the mass ratio's decline across pressures emphasizes the robustness of this metric as a predictor of system performance in varying operational conditions.

FIGS. 11C and 12C depict the Recovery Ratio (RR) as a function of Tₘₐₓ, with each line representing a different Pₕᵤₘ at two distinct levels of effectiveness. The RR increases with Tₘₐₓ, signifying that higher temperatures potentially enhance the system's energy recovery efficiency. Across both figures, the ascending trend is more stated at effectiveness of 0.8, underscoring that the system's ability to recover freshwater is augmented at this higher effectiveness level. However, the performance enhancement diminishes with increasing Pₕᵤₘ. This behavior underscores the need for careful optimization of pressure and temperature parameters to achieve the best possible scenario.

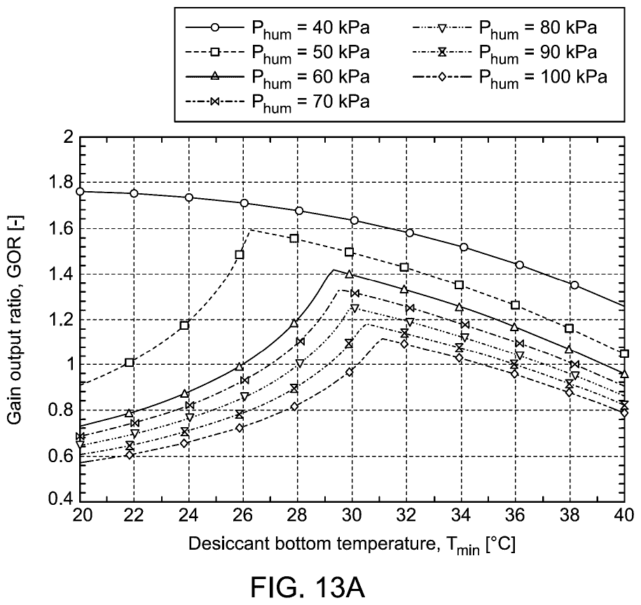

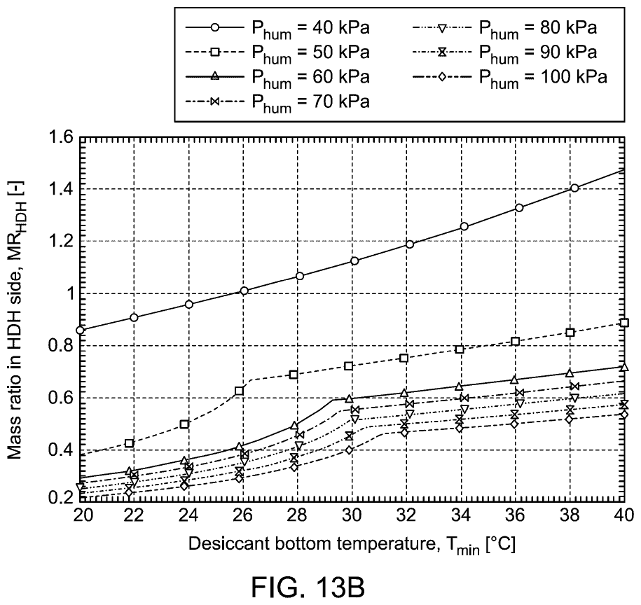

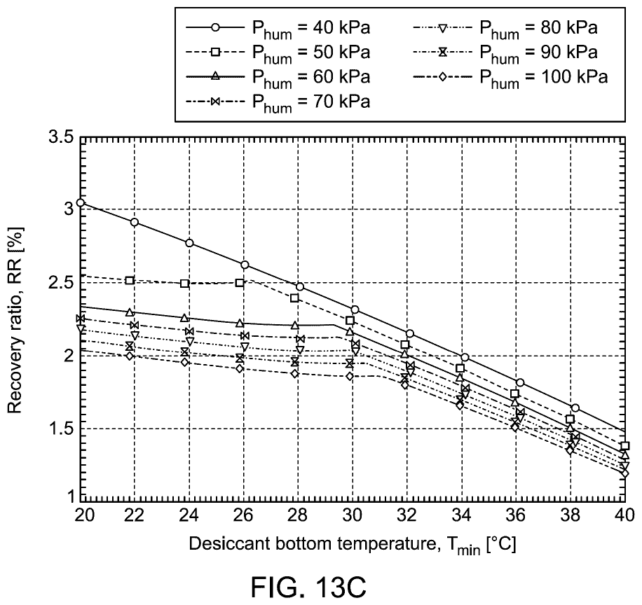

FIGS. 13A-13C illustrate the variations in (a) Gain Output Ratio, (b) mass ratio on the HDH side, and (c) recovery ratio as functions of the desiccant minimum temperature, Tₘᵢₙ, evaluated at an effectiveness of 0.7. Each metric is examined over a range of humidifier pressures, providing insights into the performance of the system under varied conditions. In FIG. 13A, the GOR is observed to increase with Tₘᵢₙ up to a certain threshold beyond which the trend reverses, indicating an optimal temperature range for maximum gain. The series of curves, distinguished by different humidity pressures, showcases the sensitivity of the GOR to both temperature and pressure, with higher dehumidifier pressures corresponding to higher GORs within the examined temperature scope. FIG. 13B portrays the mass ratio in the HDH side, which generally increases with increasing Tₘᵢₙ. This relationship is consistent across all pressures. Yet, the slope of the rise varies, reflecting how changes in the humidifier pressure influence the mass exchange efficiency within the HDH process. FIG. 13C depicts the recovery ratio (RR), revealing a decreasing trend with the rise of Tₘᵢₙ. The uniformity of the trend across different humidity pressures suggests that the temperature rather than the pressure predominantly governs the freshwater recovery efficiency of the system, although the latter still has a visible impact on the extent of the RR decrease.

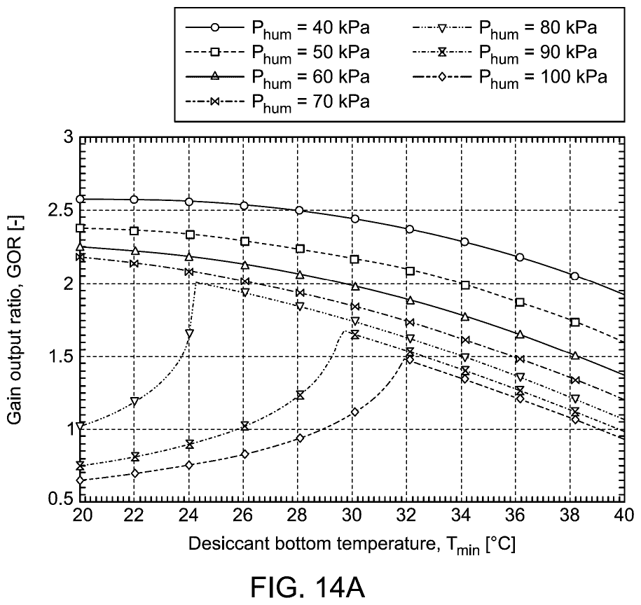

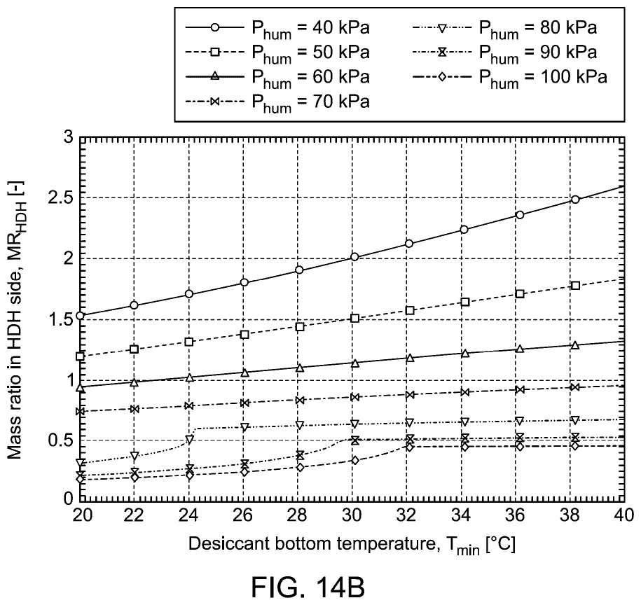

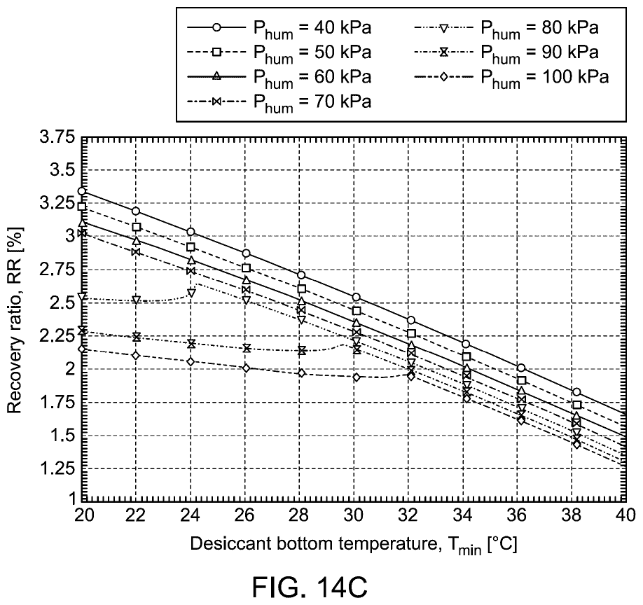

FIGS. 14A-14C offer another perspective on the performance metrics at increased effectiveness of 0.8, which results in distinct trends when compared to FIGS. 13A-13C. FIG. 14A reveals an enhanced GOR across the board as Pₕᵤₘ is decreased, notably at higher desiccant minimum temperatures. The elevated effectiveness leads to a steeper initial rise in GOR before reaching the peak, after which the decline remains gentle, underscoring the efficiency gains at this higher operational effectiveness. In FIG. 14B, while the mass ratio in the HDH side continues to increase with rising temperatures, the rate of decrease is less pronounced at this higher effectiveness. This indicates that the system retains more mass transfer capability at elevated temperatures than it did at the lower effectiveness, which could be attributed to improved system dynamics at the higher effectiveness level. FIG. 14C shows the recovery ratio (RR) displaying a similar downward trend with increasing temperature as before. However, the overall values of RR are slightly higher at this increased effectiveness, which suggests that the system is more capable of maintaining a higher recovery rate across the range of operational temperatures.

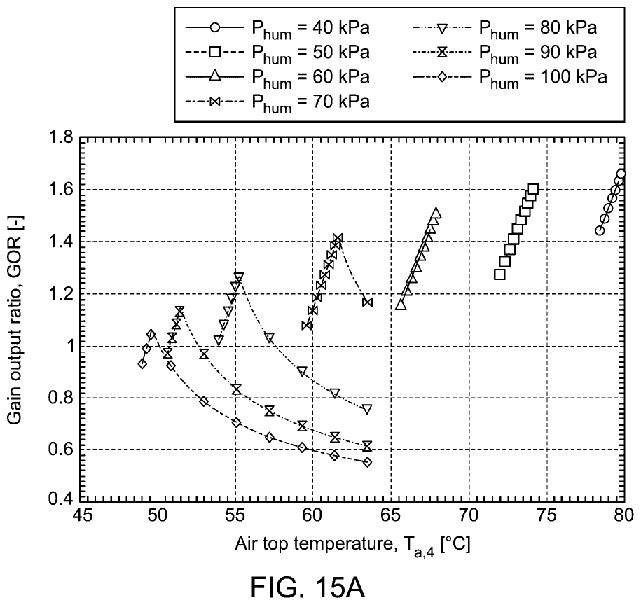

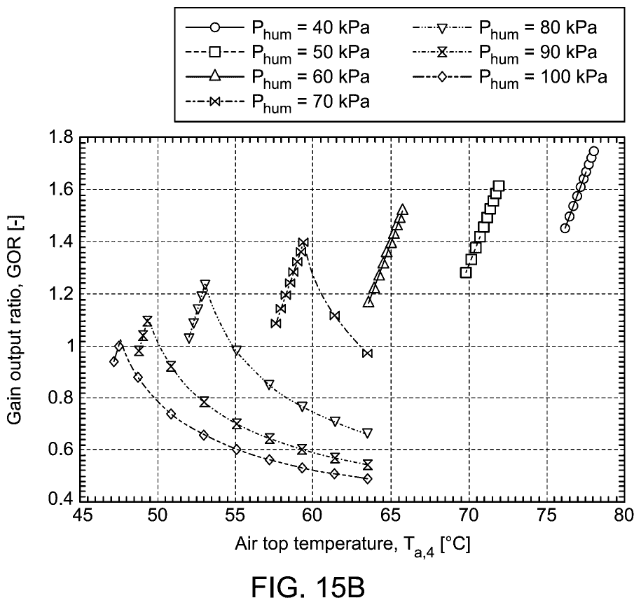

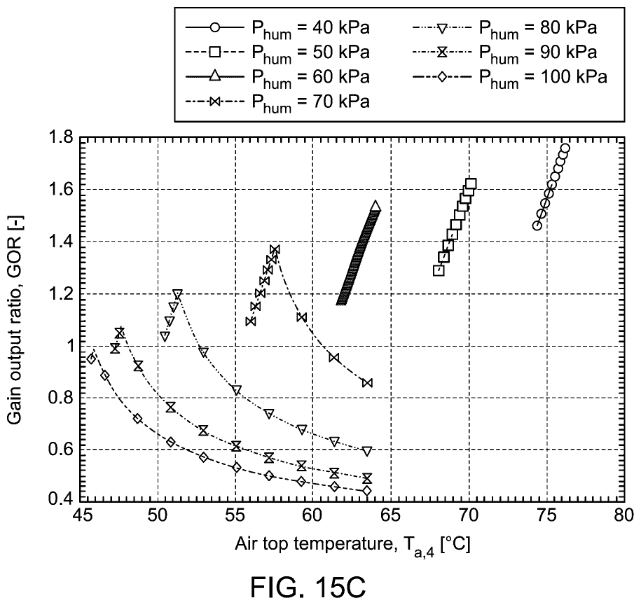

FIGS. 15A-15C interpret the Gain Output Ratio (GOR) dependency on the air top temperature under varying humidifier pressures. This relationship is explored across three distinct relative humidity (φ) air settings: 80%, 90%, and 100%, each represented in separate subfigures. FIG. 15A showcases the GOR for an 80% relative humidity, illustrating a peak in performance at mid-range temperatures, followed by a decline as temperatures continue to rise. This pattern remains consistent across different pressure settings, although with slight shifts in the temperature at which the GOR peaks. Similarly, FIG. 15B for 90% humidity exhibits analogous trends but generally records lower GOR values under similar conditions, with the performance peak occurring at slightly higher temperatures. FIG. 15C, representing 100% humidity, starts with lower initial GOR values and demonstrates a gradual decrease after reaching the peak, in contrast to the steeper declines observed at lower humidity levels. The consistency across these graphs highlights air top temperature and humidifier pressure's role in determining system efficiency. These observations emphasize the sensitivity of humidification-dehumidification system performance to these factors. This understanding is beneficial for enhancing system operational strategies.

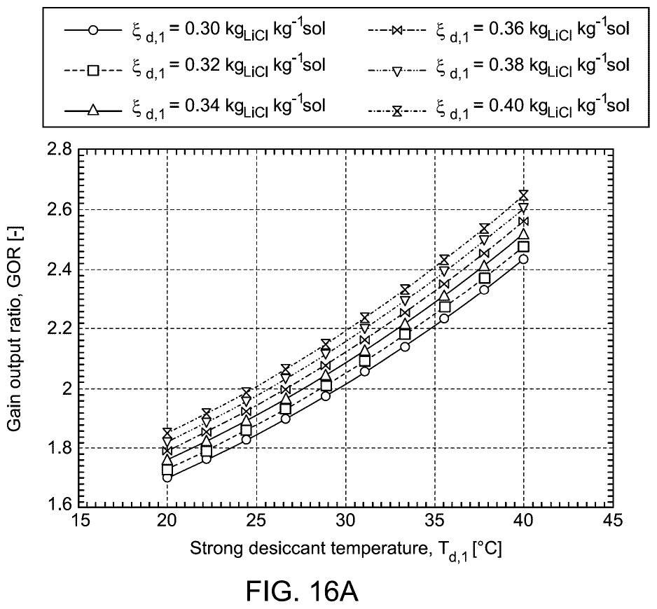

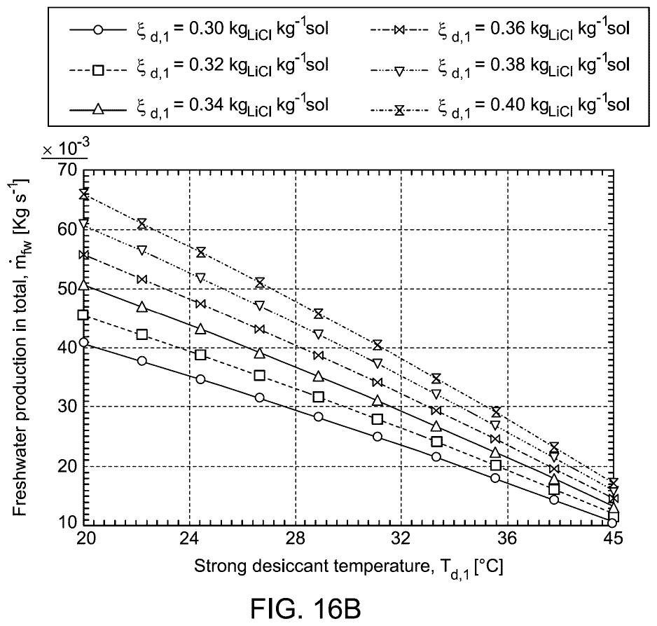

In FIGS. 16A-16B, two performance metrics of the proposed system are analyzed under varying operational conditions, specifically altering the strong desiccant temperature and concentration. FIG. 16A illustrates the system's gain output ratio (GOR). It is evident that GOR progressively increases as the temperature of the desiccant increases, across all concentration levels examined, ranging from 0.30 to 0.40 kg_{LiCl} kg⁻¹ₛₒₗ. This increase suggests that higher desiccant temperatures enhance the efficiency of the water extraction process, likely due to improved vapor pressure driving forces, which facilitate more effective water vapor absorption by the desiccant. FIG. 16B presents the variation in system productivity, measured as the rate of freshwater production in response to changes in desiccant temperature. Unlike the GOR, the productivity exhibits a decreasing trend with increasing desiccant temperature across all concentrations. This inverse relationship may be attributed to the thermal load on the system, which intensifies at higher temperatures, potentially leading to a reduced rate of water vapor condensation. Collectively, these results demonstrate the trade-offs between achieving higher GOR and maintaining optimal productivity.

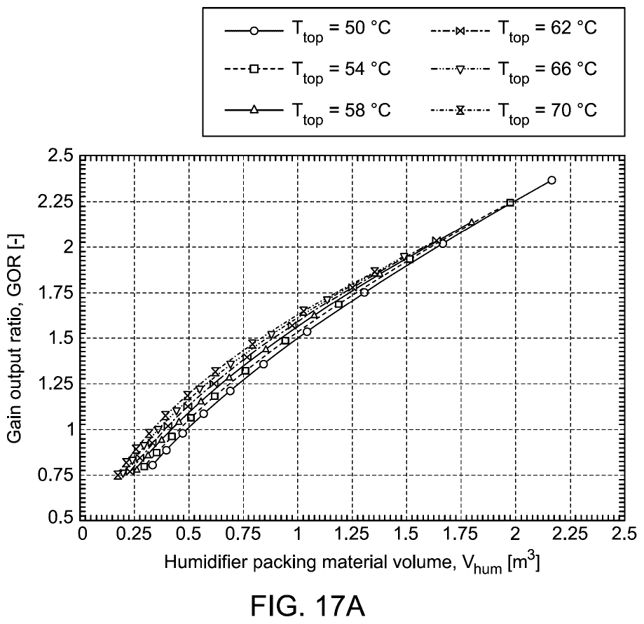

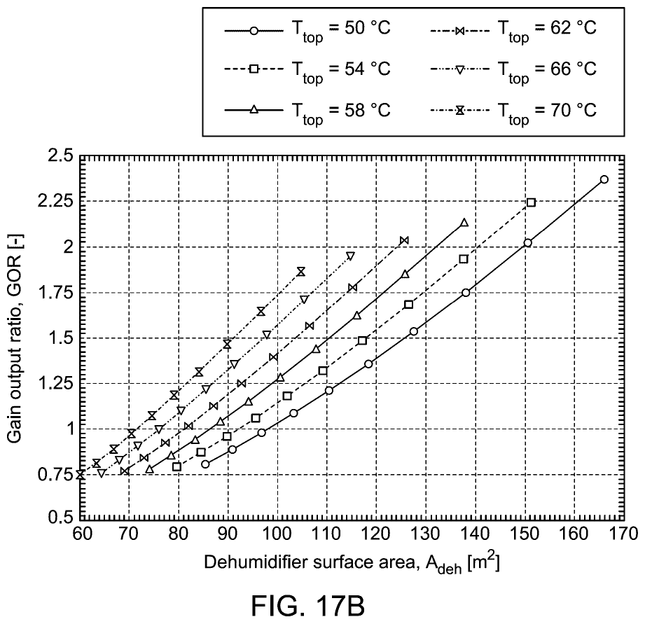

FIGS. 17A-17B provide a comprehensive analysis of the impact of component sizing on the performance of the proposed system, specifically examining how variations in the sizes of both the humidifier and dehumidifier affect the Gain Output Ratio (GOR). In FIG. 17A, the relationship between the volume of the packing material in the humidifier and the GOR is depicted across different top temperatures ranging from 50° C. to 70° C. The results consistently show a positive correlation; as the volume of the humidifier packing material increases, so does the GOR. This trend suggests that larger contact surfaces within the humidifier enhance the system's efficiency by facilitating more effective air humidification. Conversely, FIG. 17B details the effect of increasing the surface area of the dehumidifier. Similar to the humidifier results, there is a clear upward trend in GOR with larger dehumidifier surface areas. However, the slope of the increase is notably steeper compared to the humidifier scenario, indicating that the size of the dehumidifier has a more pronounced effect on the system's overall performance. This could be due to the enhanced capability of larger dehumidifiers to condense more water vapor, thereby increasing the system's output efficiency.

The following subsection offers a detailed analysis of each state point to interpret the operational dynamics of the system under basic working conditions. Table 3 systematically presents the state points, setting the mass flow rate, temperature, pressure, and humidity or concentration pertinent to air or desiccant. These parameters are specified for each stage within the system's humidifier, dehumidifier, and moisture extractor components. Such a detailed tabulation provides a transparent visualization of the system's operational flow and facilitates a precise evaluation of its efficiency and performance metrics across various operational phases.

TABLE 3
Thermodynamic state point analysis of system components (MR =
0.8811; εₕᵤₘ = ε_{deh} = 0.8; k = 1.4; PR = 1.25; Pₕᵤₘ = 40 kPa)

| | | | Humidity ratio | |
|---|---|---|---|---|
| State | Pressure | Temperature | [kg_{H2O} kg⁻¹_{d}] or | Mass flow rate |
| point | [kPa] | [°C] | concentration [%] | [kg s⁻¹] |
| a, 1 | 50 | 33.45 | 0.06372 | 1.135 |
| a, 2 | 40 | 29.88 | 0.06521 | 1.135 |
| a, 3 | 40 | 33.94 | 0.08433 | 1.135 |
| a, 4 | 50 | 54.15 | 0.08433 | 1.135 |
| d, 1 | 100 | 30.00 | 35 | 1 |
| d, 2 | 40 | 60 | 35 | 1 |
| d, 3 | 40 | 39.37 | 35.9 | 0.975 |

Further, the following section provides a comparative analysis between the proposed variable-pressure HDH system utilizing a liquid desiccant and a conventional thermal-operated HDH system. This evaluation is beneficial for highlighting the performance enhancements and operational efficiencies introduced by the proposed system design. The analysis compares operational parameters such as Gain Output Ratio (GOR), water production rate, and system pressures under similar operational conditions, offering a direct comparison to assess the relative performance benefits. This comparison explains the technical advantages and underscores potential areas for further system optimization.

Table 4 compares the proposed variable-pressure HDH system against the conventional thermal-operated HDH system, using standardized parameters to provide an equitable assessment. Both systems operate with the same mass ratio (MR) and effectiveness parameters for the humidifier and dehumidifier (εₕᵤₘ, ε_{deh}), yet differ in their pressure ratio (PR) and system pressures (Pₕᵤₘ, P_{deh}), which aids in evaluating their efficiency. Notably, the proposed system achieves a higher Gain Output Ratio (GOR) of 2.28 compared to 1.71 in the conventional system, indicating enhanced efficiency in converting thermal energy into water vapor. Despite similar water production rates, the slight differences in recovery ratio (RR) reflect the impact of operating pressures on system performance. This comparative analysis substantiates the proposed system's improved performance metrics, demonstrating its potential advantages over traditional HDH systems regarding energy utilization and operational effectiveness.

TABLE 1
Comparison of the proposed system with the conventional
Humidification-dehumidification system (MR =
0.8811; εₕᵤₘ = ε_{deh} = 0.8; k = 1.4; PR = 1.25;
Pₕᵤₘ = 40 kPa)

| | Proposed | Thermal-operated |
|---|---|---|
| Parameter [Unit] | system | HDH system |
| MR [—] | 0.8811 | 0.8811 |
| εₕᵤₘ [—] = ε_{deh} [—] | 0.8 | 0.8 |
| PR [—] | 1.25 | 1 |
| Pₕᵤₘ [—] | 40 | 100 |
| P_{deh} [—] | 50 | 100 |
| Tₘᵢₙ [°C] | 30 | 30 |
| Tₘₐₓ [°C] | 60 | 60 |
| GOR [—] | 2.28 | 1.71 |
| Production [kg s⁻¹] | 0.0251 | 0.0253 |
| RR [%] | 2.51 | 2.53 |

The following section provides a comparative analysis with compressor-based air-cooling atmospheric water generators. Table 5 presents a comparative analysis of specific power consumption, measured in kilowatt-hours per liter (kWh/L), between the proposed system and conventional compressor-based air-cooling atmospheric water generators (AWGs). Data from three different studies [See: Bagheri F. Performance investigation of atmospheric water harvesting systems. Water Resour Ind, 2018; 20:23-8; Patel K, Patel J, Raval H. Potential Study of Atmospheric Water Generator (AWG) for Humid Climatic Conditions of Eastern States in India. Smart Innov. Syst. Technol., vol. 161, 2020, p. 239-48; Faraz Ahmad F, Ghenai C, Al Bardan M, Bourgon M, Shanableh A. Performance analysis of atmospheric water generator under hot and humid climate conditions: Drinkable water production and system energy consumption. Case Stud Chem Environ Eng, 2022; 6, incorporated herein by reference in their entirety] reveal that the specific power consumption for conventional AWGs ranged from a minimum of 0.75 kWh/L to a maximum of 6.23 kWh/L. In contrast, the proposed system demonstrates lower energy consumption, ranging from 0.27 kWh/L to 1.11 kWh/L. This reduction highlights the enhanced efficiency of the proposed system in terms of energy utilization for water generation.

TABLE 5
Comparison of the proposed system with compressor-
based air-cooling atmospheric water generator (AWG)

Specific power consumption (kWh/L)

| Parameter [Unit] | Minimum | Maximum |
|---|---|---|
| compressor-based air- | 1.02 | 6.23 |
| cooling AWG | | |
| [Bagheri F] | | |
| compressor-based air- | 0.75 | 4.71 |
| cooling AWG | | |
| [Patel K et al.] | | |
| compressor-based air- | 0.84 | 1.98 |
| cooling AWG | | |
| [Faraz Ahmad F et al.] | | |
| Proposed system | 0.27 | 1.11 |

In conclusion, the present disclosure introduces a zero-brine discharge approach, eliminating the necessity for continuous seawater input and brine disposal, which are major drawbacks in traditional desalination methods. The present disclosure provides a humidification-dehumidification (HDH) system operating under variable pressures, boosting efficiency. The system comprises two synergistic components: a variable-pressure HDH unit and a desiccant-based moisture extractor utilizing a lithium chloride solution. After freshwater is extracted, the concentrated desiccant cycles through the moisture extractor to absorb atmospheric water vapor, diluting it for reuse and thus completing the desiccant loop. The heat and mass transfer processes were scrutinized through mathematical modeling, and parameters for maximizing the Gain Output Ratio (GOR) were optimized. The results underscore the system's capacity for sustainable, efficient freshwater production. This methodology offers a feasible solution to challenges in desalination and contributes to alleviating global water scarcity, particularly in coastal areas. Further analysis shows that systematic optimization of parameters, such as pressure ratios and desiccant temperatures, considerably improves performance metrics. Adjusting the pressure ratio from 1.22, where the GOR peaks at 2.44, to 1.56 directly impacts system efficiency. Modulating the maximum desiccant temperature at an optimal pressure ratio of 1.25 reveals that the GOR can increase from 1.635 at 0.7 to 2.441 at an effectiveness of 0.8. Optimized manipulation of these parameters can potentially enhance the GOR by up to 50% and improve mass transfer efficiency by about 20% within the HDH process.

The zero-brine discharge system proposed in the present disclosure removes the ongoing requirement for source and sink provisions typical in conventional desalination processes. Given the substantial volume of water present in the earth's atmosphere, it serves as a dependable source of fresh water, particularly in coastal regions. The present disclosure introduces a novel atmospheric water generator. The design of the system consists of two main components: a variable-pressure Humidification-Dehumidification (HDH) system that employs a liquid desiccant solution as opposed to saline water and a moisture extractor based on desiccant technology. An evaluation of the modified HDH system has been conducted. This system demonstrates excellent performance. A notable aspect of this system is its operation at reduced pressures, necessitating strict measures to prevent leakages, as external air may infiltrate the lower-pressure components more easily. The present disclosure indicates that enhancing the (PR) while concurrently lowering the humidifier pressure markedly improves the Gain Output Ratio (GOR). The prominent shifts in trend patterns observed are attributed to the transition in the efficiency of the system's components from being predominantly influenced by the desiccant and air. Around 10% of the condensed freshwater is generated in the throttle. However, with an increase in PR, the contribution of the throttle condensation reduces, leading to a higher proportion of water being produced in the dehumidifier.

The system of the present disclosure employs strategic fluid handling and thermal management to optimize both moisture extraction and desiccant regeneration processes. The present disclosure achieves enhanced performance metrics while reducing operational complexity by leveraging thermodynamic principles and advanced flow control. The system of the present disclosure has a modular configuration which facilitates scaling and customization for specific deployment scenarios while providing consistent performance. Further, the integrated design of the system enables deployment across diverse applications, from small-scale residential use to industrial implementation, while maintaining adaptability to varying atmospheric conditions.

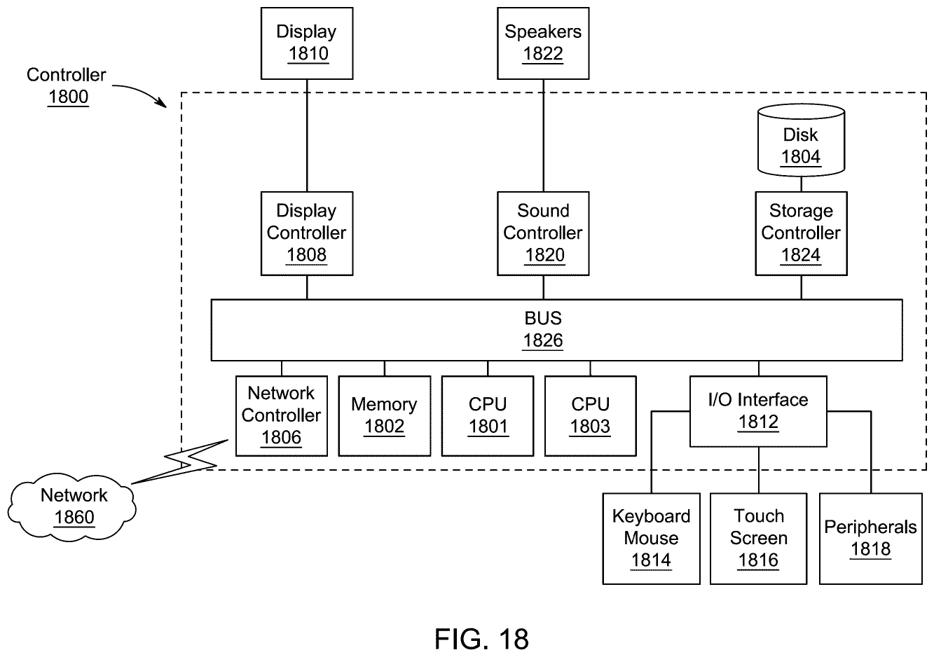

Next, further details of the hardware description of a computing environment according to exemplary embodiments is described with reference to FIG. 18. In FIG. 18, a controller 1800 is described as representative of a controlling unit of the present system 100 to control operations of various electrical components therein, in which the controller 1800 is a computing device which includes a CPU 1801 which performs the processes described above/below. The process data and instructions may be stored in memory 1802. These processes and instructions may also be stored on a storage medium disk 1804 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1801, 1803 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 1801 or CPU 1803 may be a Xenon or Core processor from Intel of America or an Opteron processor from AMD of America, or may be other processor types that would be recognized by one of ordinary skill in the art. Alternatively, the CPU 1801, 1803 may be implemented on an FPGA, ASIC, PLD or using discrete logic circuits, as one of ordinary skill in the art would recognize. Further, CPU 1801, 1803 may be implemented as multiple processors cooperatively working in parallel to perform the instructions of the inventive processes described above.

The computing device in FIG. 18 also includes a network controller 1806, such as an Intel Ethernet PRO network interface card from Intel Corporation of America, for interfacing with network 1860. As can be appreciated, the network 1860 can be a public network, such as the Internet, or a private network such as an LAN or WAN network, or any combination thereof and can also include PSTN or ISDN sub-networks. The network 1860 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1808, such as a NVIDIA GeForce GTX or Quadro graphics adaptor from NVIDIA Corporation of America for interfacing with display 1810, such as a Hewlett Packard HPL2445w LCD monitor. A general purpose I/O interface 1812 interfaces with a keyboard and/or mouse 1814 as well as a touch screen panel 1816 on or separate from display 1810. General purpose I/O interface also connects to a variety of peripherals 1818 including printers and scanners, such as an OfficeJet or DeskJet from Hewlett Packard.

A sound controller 1820 is also provided in the computing device such as Sound Blaster X-Fi Titanium from Creative, to interface with speakers/microphone 1822 thereby providing sounds and/or music.

The general purpose storage controller 1824 connects the storage medium disk 1804 with communication bus 1826, which may be an ISA, EISA, VESA, PCI, or similar, for interconnecting all of the components of the computing device. A description of the general features and functionality of the display 1810, keyboard and/or mouse 1814, as well as the display controller 1808, storage controller 1824, network controller 1806, sound controller 1820, and general purpose I/O interface 1812 is omitted herein for brevity as these features are known.

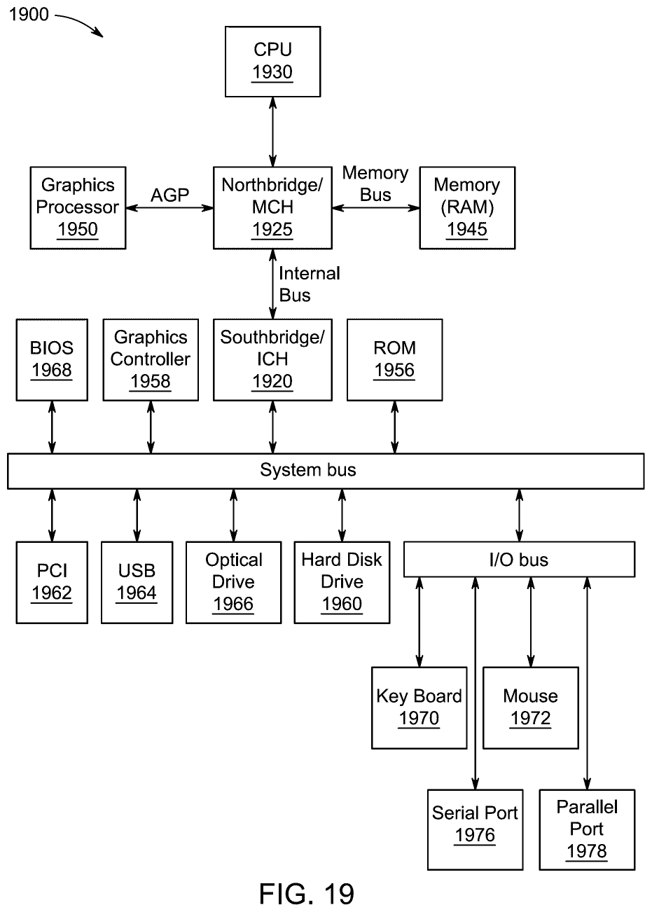

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 19.

FIG. 19 shows a schematic diagram of a data processing system, according to certain embodiments, for performing the functions of the exemplary embodiments. The data processing system is an example of a computer in which code or instructions implementing the processes of the illustrative embodiments may be located.

In FIG. 19, data processing system 1900 employs a hub architecture including a north bridge and memory controller hub (NB/MCH) 1925 and a south bridge and input/output (I/O) controller hub (SB/ICH) 1920. The central processing unit (CPU) 1930 is connected to NB/MCH 1925. The NB/MCH 1925 also connects to the memory 1945 via a memory bus, and connects to the graphics processor 1950 via an accelerated graphics port (AGP). The NB/MCH 1925 also connects to the SB/ICH 1920 via an internal bus (e.g., a unified media interface or a direct media interface). The CPU Processing unit 1930 may contain one or more processors and even may be implemented using one or more heterogeneous processor systems.

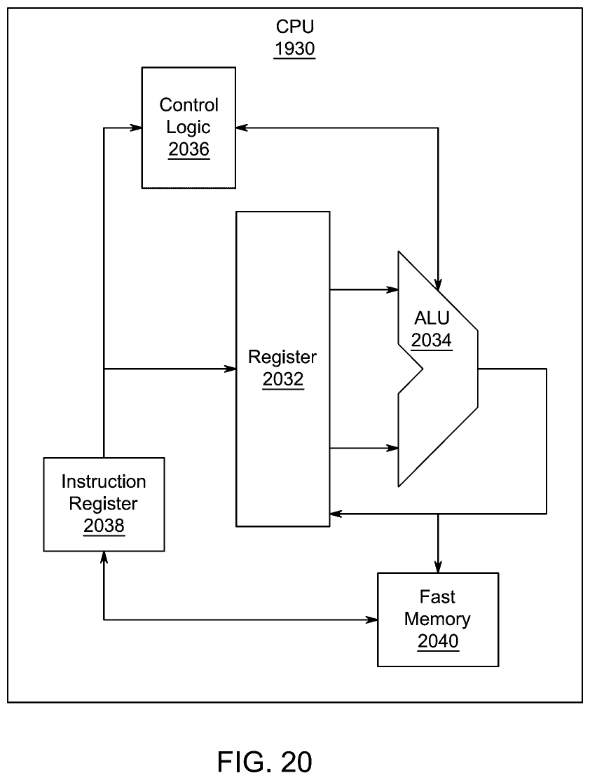

For example, FIG. 20 shows one implementation of CPU 1930. In one implementation, the instruction register 2038 retrieves instructions from the fast memory 2040. At least part of these instructions are fetched from the instruction register 2038 by the control logic 2036 and interpreted according to the instruction set architecture of the CPU 1930. Part of the instructions can also be directed to the register 2032. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 2034 that loads values from the register 2032 and performs logical and mathematical operations on the loaded values according to the instructions. The results from these operations can be feedback into the register and/or stored in the fast memory 2040. According to certain implementations, the instruction set architecture of the CPU 1930 can use a reduced instruction set architecture, a complex instruction set architecture, a vector processor architecture, a very large instruction word architecture. Furthermore, the CPU 1930 can be based on the Von Neuman model or the Harvard model. The CPU 1930 can be a digital signal processor, an FPGA, an ASIC, a PLA, a PLD, or a CPLD. Further, the CPU 1930 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 19, the data processing system 1900 can include that the SB/ICH 1920 is coupled through a system bus to an I/O Bus, a read only memory (ROM) 1956, universal serial bus (USB) port 1964, a flash binary input/output system (BIOS) 1968, and a graphics controller 1958. PCI/PCIe devices can also be coupled to SB/ICH 1988 through a PCI bus 1962.

The PCI devices may include, for example, Ethernet adapters, add-in cards, and PC cards for notebook computers. The Hard disk drive 1960 and CD-ROM 1966 can use, for example, an integrated drive electronics (IDE) or serial advanced technology attachment (SATA) interface. In one implementation the I/O bus can include a super I/O (SIO) device.

Further, the hard disk drive (HDD) 1960 and optical drive 1966 can also be coupled to the SB/ICH 1920 through a system bus. In one implementation, a keyboard 1970, a mouse 1972, a parallel port 1978, and a serial port 1976 can be connected to the system bus through the I/O bus. Other peripherals and devices that can be connected to the SB/ICH 1920 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

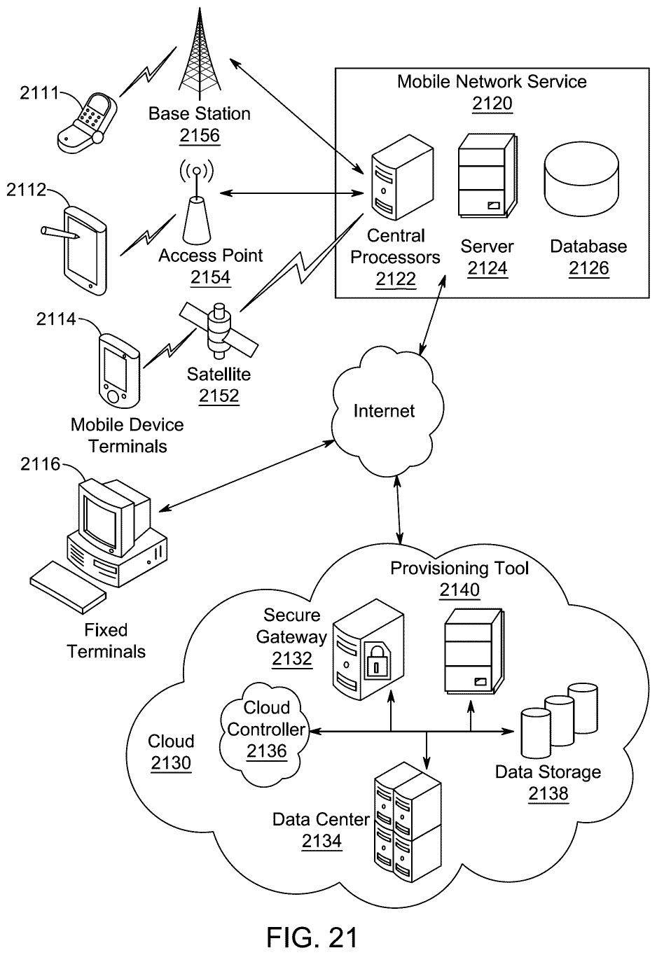

The functions and features described herein may also be executed by various distributed components of a system. For example, one or more processors may execute these system functions, wherein the processors are distributed across multiple components communicating in a network. The distributed components may include one or more client and server machines, such as cloud 2130 including a cloud controller 2136, a secure gateway 2132, a data center 2134, data storage 2138 and a provisioning tool 2140, and mobile network services 2120 including central processors 2122, a server 2124 and a database 2126, which may share processing, as shown by FIG. 21, in addition to various human interface and communication devices (e.g., display monitors 2116, smart phones 2110, tablets 2112, personal digital assistants (PDAs) 2114). The network may be a private network, such as a LAN, satellite 2152 or WAN 2154, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

While specific embodiments of the disclosure have been described, it should be understood that various modifications and alternatives may be implemented without departing from the spirit and scope of the disclosure. For example, different cellular automata rules or encryption algorithms could be employed, or alternative feature extraction and face recognition techniques could be integrated into the system.

The above-described hardware description is a non-limiting example of corresponding structure for performing the functionality described herein.

Numerous modifications and variations of the present disclosure are possible in light of the above teachings. It is therefore to be understood that within the scope of the appended claims, the disclosure may be practiced otherwise than as specifically described herein.

1. A system for production of water from air, comprising:
an air intake, which conveys humid air from the environment to a desiccant-based moisture extractor;
the desiccant-based moisture extractor, wherein the humid air is dried with a desiccant to produce a weak desiccant and a dry air, wherein the weak desiccant is conveyed to a dehumidifier through a weak desiccant line and the dry air is directed away from the air intake;
the dehumidifier comprising a vessel, a water outlet, and a wet compressed air inlet, wherein a weak desiccant cooling line passes through the vessel of the dehumidifier and conveys the weak desiccant to a humidifier, wherein the wet compressed air inlet allows for a wet compressed air to pass over the weak desiccant cooling line, wherein the wet compressed air is cooled by exposure to the weak desiccant cooling line, producing a dry pressurized air and condensed water, wherein the water outlet conveys the condensed water to a freshwater storage tank;
a dry pressurized air line, connecting the vessel of the dehumidifier to a body of the humidifier, wherein a throttle valve is disposed in line with the dry pressurized air line downstream from the dehumidifier and upstream from the humidifier;
the throttle valve, wherein the throttle valve is configured to allow the dry pressurized air from the dehumidifier to flow into the humidifier, thereby introducing a dry air into the humidifier;
the humidifier comprising the body, a strong desiccant outlet, and a wet air outlet, wherein the dry air is exposed to weak desiccant to produce a wet air and strong desiccant, wherein the wet air is fed through the wet air outlet to a compressor line, and the strong desiccant is conveyed to the desiccant-based moisture extractor through a strong desiccant line;
the compressor line, which connects the wet air outlet to the wet compressed air inlet; and
a compressor, wherein the compressor sits in line with the compressor line and compresses the wet air to form the wet compressed air, wherein the wet compressed air is fed to the wet compressed air inlet,
wherein the dehumidifier, the dry pressurized air line, the humidifier, and the compressor line form a closed gas loop, and
wherein the weak desiccant line, the weak desiccant cooling line, the strong desiccant line, and the desiccant-based moisture extractor form a closed desiccant loop.

2. The system of claim 1, wherein the Gain Output Ratio is greater than or equal to 2.00.

3. The system of claim 2, wherein the Gain Output Ratio is greater than or equal to 2.20.

4. The system of claim 1, wherein the recovery ratio is greater than or equal to 2.00.

5. The system of claim 4, wherein the recovery ratio is greater than or equal to 2.40.

6. The system of claim 1, wherein the Gain Output Ratio is greater than or equal to 1.20 when operated at a pressure ratio of 1.4, assuming an effectiveness parameter of 0.7, and wherein a pressure of the humidifier is 80 kPa.

7. The system of claim 1, wherein the Gain Output Ratio is greater than or equal to 1.30 when operated at a pressure ratio of 1.4, assuming an effectiveness parameter of 0.7, and wherein a pressure of the humidifier is 70 kPa.

8. The system of claim 1, wherein the Gain Output Ratio is greater than or equal to 1.37 when operated at a pressure ratio of 1.4, assuming an effectiveness parameter of 0.7, and wherein a pressure of the humidifier is 60 kPa.

9. The system of claim 1, wherein the Gain Output Ratio is greater than or equal to 1.47 when operated at a pressure ratio of 1.4, assuming an effectiveness parameter of 0.7, and wherein a pressure of the humidifier is 50 kPa.

10. The system of claim 1, wherein the Gain Output Ratio is greater than or equal to 1.60 when operated at a pressure ratio of 1.4, assuming an effectiveness parameter of 0.7, and wherein a pressure of the humidifier is 40 kPa.

11. The system of claim 1, wherein the recovery ratio is greater than or equal to 2.00 when operated at a pressure ratio of 1.4, assuming an effectiveness parameter of 0.7, and wherein a pressure of the humidifier is 80 kPa.

12. The system of claim 1, wherein the recovery ratio is greater than or equal to 2.075 when operated at a pressure ratio of 1.4, assuming an effectiveness parameter of 0.7, and wherein a pressure of the humidifier is 70 kPa.

13. The system of claim 1, wherein the recovery ratio is greater than or equal to 2.15 when operated at a pressure ratio of 1.4, assuming an effectiveness parameter of 0.7, and wherein a pressure of the humidifier is 60 kPa.

14. The system of claim 1, wherein the recovery ratio is greater than or equal to 2.20 when operated at a pressure ratio of 1.4, assuming an effectiveness parameter of 0.7, and wherein a pressure of the humidifier is 50 kPa.

15. The system of claim 1, wherein the recovery ratio is greater than or equal to 2.30 when operated at a pressure ratio of 1.4, assuming an effectiveness parameter of 0.7, and wherein a pressure of the humidifier is 40 kPa.

16. The system of claim 1, wherein the total freshwater production is greater than or equal to a water mass flow rate of 20×10⁻³ kg·s⁻¹ when operated at a pressure ratio of 1.4, assuming an effectiveness parameter of 0.7, and wherein a pressure of the humidifier is 80 kPa.

17. The system of claim 1, wherein the total freshwater production is greater than or equal to a water mass flow rate of 20.8×10⁻³ kg·s⁻¹ when operated at a pressure ratio of 1.4, assuming an effectiveness parameter of 0.7, and wherein a pressure of the humidifier is 70 kPa.

18. The system of claim 1, wherein the total freshwater production is greater than or equal to a water mass flow rate of 21.5×10⁻³ kg·s⁻¹ when operated at a pressure ratio of 1.4, assuming an effectiveness parameter of 0.7, and wherein a pressure of the humidifier is 60 kPa.

19. The system of claim 1, wherein the total freshwater production is greater than or equal to a water mass flow rate of 22.0×10⁻³ kg·s⁻¹ when operated at a pressure ratio of 1.4, assuming an effectiveness parameter of 0.7, and wherein a pressure of the humidifier is 50 kPa.

20. The system of claim 1, wherein the total freshwater production is greater than or equal to a water mass flow rate of 23.0×10⁻³ kg·s⁻¹ when operated at a pressure ratio of 1.4, assuming an effectiveness parameter of 0.7, and wherein a pressure of the humidifier is 40 kPa.
